(19) United States
(12) Patent Application Publication
(10) Pub. No.: US 2023/0134697 A1
(43) Pub. Date: May 4, 2023

(54) MULTI-USE, REUSABLE, SPILL PROOF PACKAGE FOR FLUIDS WITHOUT A REMOVABLE OR SEPARABLE CLOSURE

(71) Applicants: William S. PERELL, San Francisco, CA (US); Cheryl Elizabeth HARRISON, San Francisco, CA (US); POPPACK LLC, San Francisco, CA (US)

(72) Inventors: William S. PERELL, San Francisco, CA (US); Cheryl Elizabeth HARRISON, San Francisco, CA (US)

(21) Appl. No.: 18/009,727

(22) PCT Filed: Jun. 10, 2021
(86) PCT No.: PCT/US2021/036784

§ 371 Date: Dec. 11, 2022

Related U.S. Application Data
(60) Provisional application No. 63/038,028, filed on Jun. 11, 2020.

(51) Int. Cl. B65D 75/58; B65D 75/42; B65D 65/46

(52) U.S. Cl. CPC B65D 75/5811; B65D 65/466; B65D 75/42

(57) ABSTRACT

A one-piece package or container is disclosed that includes an opening device in conjunction with a self-closing valve for facilitating opening of the package and for dispensing fluids in a controlled manner. In one embodiment, the opening device can include at least one breachable bubble. The at least one breachable bubble can be formed by a seal along a perimeter and/or fluid channel of the package. The package includes a fluid channel with a self-closing valve that can be opened by breaching the breachable bubble. After the package is opened, the self-closing valve prevents fluid from flowing through the fluid channel until pressure is applied to the package, such as pressure through squeezing . Thus, when a user applies pressure to the package, the contents of the package can be dispensed through the fluid channel in a controlled manner.

### BACKGROUND

In the year 2017, global production of plastics reached 348 million metric tons. Roughly half of annual plastic production is destined for a single-use product, including plastic drinking bottles. Humans buy about 1,000,000 plastic bottles per minute, resulting in sales of more than 480 billion plastic drinking bottles worldwide in 2016. Along with plastic drinking bottles, over half a million disposable plastic straws are used by Americans every day. Moreover, 91% of all plastic is discarded and not recycled.

The discarded single-use plastics, including plastic drinking bottles, caps, fitments, tear strips and labels are harmful to the environment. Not only do discarded single-use plastics fill up landfills, but they also are frequently left to flow into lakes and streams, ending up in rivers and ultimately oceans around the world. Instead of evenly dispersing in the oceans, plastic waste tends to concentrate in the northern and southern gyres, or systems of circular currents, in the oceans, such as what has become known as the “Great Pacific Garbage Patch” in the northern Pacific gyre. The region is currently estimated to have a size of at least 700,000 square kilometers (270,000 square miles — about the size of the state of Texas, or the size of France and Switzerland combined). It has been estimated that over 18,000 pieces of plastic exist within each square kilometer of the patch. Samples from the Great Pacific Garbage Patch reveal that the mass of plastic waste exceeded that of zooplankton, which is the dominant animal life in the area, and it is further estimated that by the year 2050, there will be more plastic than fish in the oceans.

Plastic waste, particularly in water streams and oceans such as in the Great Pacific Garbage Patch, is subject to plastic photodegradation which causes plastic to degrade into small toxic plastic polymers. Over time, the plastic polymers disintegrate into smaller and smaller pieces, transforming into “microplastics,” or until the molecular level is reached. However, the majority of these polymers are not bio-based or compostable, and typically do not decompose without harming the environment. These small toxic plastic polymers (microplastics) contaminate the air, water, and soil, and are ultimately ingested by aquatic organisms including fish, thus resulting in plastic waste entering the food chain for animal and human consumption.

To address the problem of plastic waste, recycling has been introduced into the plastic consumption cycle. However, only a limited portion of plastic waste is sent to recycling facilities. For example, globally over 91% of plastic is not recycled, and only 23% of plastic bottles are recycled in the United States. Moreover, existing plastic bottles and fluid containers utilize multiple types of plastics for their different parts, such as polyethylene terephthalate (PET) for the bottle and polypropylene (PP) for the more rigid bottlecap or closure. Plastic bottles additionally often utilize different plastic or film materials wrapped around the bottle to include label information and chemical adhesives. Because each plastic material used, such as PET and PP, has distinct melting points that are significantly different from the respective other plastic materials, all of the materials must be separated from one another before being melted down for reuse. Thus, the recycling of existing plastic bottles can be economically ineffective because it entails various processes, including collecting, cleaning, and sorting the plastic waste and separately processing of each of the waste materials into materials that can be used in new products. As such, due to the time, money, and infrastructure cost of the collecting and processing, recycling is not widely available, and if available, recycling is often not mandatory. Thus, many people do not have a convenient venue for recycling or may merely choose not to recycle, or lack awareness of recycling as a waste management method.

Despite the many problems caused by plastic waste around the world, it is estimated that replacing plastics in packaging and consumer products with alternative materials could raise environmental costs multi-fold. Thus, rather than finding or developing materials to replace plastics, there is a critical need for innovation for the design and development of new forms of packaging and materials that use less material are more easily recyclable as compared to existing single-use plastic packaging, as well as improving, collecting and sorting and the infrastructure for increasing the recycling of growing volumes of plastic waste.

One solution to the above problems of plastic waste with existing plastic bottles and containers has been to package liquid products in flexible containers made from one or more layers of polymer film. In addition to reducing the amount of plastic material per container compared to existing plastic bottles, packages made from polymer films can offer additional advantages. For instance, the polymer films can be wrapped tightly around the products for eliminating void space and minimizing packaging materials required. The resulting packages are not very bulky, are easy to handle and have a lighter weight. The polymer films can sometimes be translucent or transparent, allowing a purchaser to view the contents prior to making the purchase. In addition, the polymer films can be printed with decorative graphics to make the product more attractive.

Although packages made from polymer films can provide various advantages, opening such packages can be quite difficult. For example, the polymer films must have sufficient seal strength to prevent against accidental rupture. Increasing the strength of the film or the seals that surround the content of the package, however, often increases the difficulty in opening the package. For example, many such packages that contain liquid or flowable substances, do not include an easy opening feature. Thus, brute force, scissors, a knife, biting with one’s teeth, or another suitable instrument need to be used in order to open the package.

Another disadvantage to containers made from one or more layers of polymer films is that the films are not always compatible with each other and various layers may not be easily recycled. Consequently, multilayer films can restrict easy recyclability and create solid waste generation.

Further, a greater need exists for packages that are not only sustainable, but also can be made, shipped and delivered with stringent hygiene requirements due to the global COVID-19 pandemic. The ability to make a package from a single material that is easy to open, and without product spillage, would greatly enhance the sustainability of the package balanced with better hygiene characteristics.

In view of the above, those skilled in the art have attempted to improve the manner in which packages and containers are constructed and opened. For instance, PopPack LLC has made many significant and meritorious advances in the design and construction of packages and particularly in the design of techniques and methods for opening packages and containers. Examples of opening devices for packages are disclosed in, for example, U.S. Pat. No. 6,726,364 to Perell et al., U.S. Pat. No. 6,938,394 to Perell, U.S. Pat. No. 7,306,371 to Perell, U.S. Pat. No. 7,644,821 to Perell, U.S. Pat. No. RE 41,273 to Perell, U.S. Pat. Appl. Pub. No. 20080212904 to Perell, U.S. Pat. Appl. Pub. No. 20070295766 to Perell, U.S. Pat. Appl. Pub. No. 20070286535 to Perell, U.S. Pat. Appl. Pub. No. 20070284375 to Perell, U.S. Pat. Appl. Pub. No. 20070241024 to Perell, U.S. Pat. Appl. Pub. No. 20070237431 to Perell, U.S. Pat. Appl. Pub. No. 20070235369 to Perell, U.S. Pat. Appl. Pub. No. 20070235357 to Perell, U.S. Pat. Appl. Pub. No. 20060126970 to Perell, U.S. Pat. Appl. Pub. No. 20040231292 to Perell, and U.S. Pat. Appl. Pub. No. 20040057638 to Perell et al. The subject matter of each of the above-referenced issued patents and published applications is fully incorporated herein by reference.

Another problem with such previously made polymer film containers is that it is typically difficult to dispense the fluid in a controlled manner. These containers, for instance, are opened by tearing the top off the container, tearing a corner, cutting with scissors or knives, or inserting a straw into the container. Since the packages are flexible, the containers are prone to spill their contents, especially when any type of pressure is applied to the container. Once open, and in the absence of a separate rigid pouring valve welded or glued to the container or otherwise affixed, these receptacles cannot be re-closed easily, and tend to allow the liquid to escape, and expose the liquid to air and possibly to other contaminants. The user is therefore obliged to hold the receptacle once it has been opened, since it cannot be placed on a table or other surface before it has been completely emptied, in order to avoid accidental leaks and contamination and cannot be reclosed.

In view of the above, the present disclosure is generally directed to an improved polymer film container that utilizes less material, less energy and less water in cleaning and more efficient production lines than a plastic bottle, e.g., a single material film formed from a single polymer, is relatively easy to open and has a built-in self-closing pour channel for dispensing fluids from the container in a controlled manner without being prone to accidental spillage.

### SUMMARY

In general, the present disclosure is directed to a multi-use, reusable, spill proof package for fluids without a removable or separable closure. In one embodiment, the package includes a flexible container having an interior volume for receiving a flowable substance. The flexible container of the package defines a sealed periphery. The package further includes a breachable point located along the sealed periphery of the flexible container. The breachable point has a weaker seal than the remainder of the sealed periphery. The package further includes a fluid channel including a fluid outlet and at least one valve-like passageway. The fluid outlet is located adjacent to the breachable point, and the at least one valve-like passageway is in fluid communication with the interior volume of the flexible container. The package further includes a self-closing valve including a barrier member positioned between the fluid outlet and the interior volume of the flexible container. The at least one valve-like passageway is formed between the barrier member and the sealed periphery. Pressure applied to the flexible container causes the breachable point to breach for dispensing controlled amounts of the flowable substance from the interior volume of the container. When pressure is no longer applied, the self-closing valve inhibits further flow of the flowable substance through the fluid outlet.

The package of the present disclosure may hold and dispense compositions, such as fluids. A fluid can be a liquid, flowable substance or a gas. The liquid, for instance, can be free flowing and can be lightly to highly viscous. The package, for instance, can hold fluids, such as beverages, edible oils, condiments, personal care products, industrial products, automotive lubricants, health care products, liquid soaps and detergents, hair care products, sunscreen compositions, cleaning products, and the like.

In one embodiment, the package includes a flexible container defining an interior volume for receiving a fluid. The flexible container may be comprised of a flexible polymer film. The package further includes a fluid channel having a first end connecting the fluid outlet to the ambient and an opposite second end connecting to the interior fluid volume. The fluid channel is in communication with a fluid outlet at the first end and is connected to the interior volume of the flexible container at the second end. The flexible container additionally contains a self-closing valve of various forms and shapes. Pressure applied to the flexible pouch (such as a user-applied squeeze) opens at least one passageway between the interior volume and the fluid channel. The package also contains at least one breachable point or bubble located along or in close proximity to the outside perimeter of the flexible container. Breaching the bubble or breachable point results in fluid communication between the fluid outlet and the ambient. The breachable bubble after bursting by external pressure opens the seal. The breachable bubble and self-closing valve additionally prevents flow through the fluid outlet to the ambient.

The breachable bubble seal may contain a weakened portion in order to influence the breachable point or portion of the seal to the perimeter of the sealing portion.

In one embodiment, the self-closing valve is formed by placing a barrier member attached to the flexible container walls. The barrier member can simply be a seal of opposing layers in a specified location. The barrier member can be located adjacent to the second end of the fluid channel so that at least one valve-like passageway is formed between the second end of the fluid channel and the interior volume of the container. When the package is filled, the shape of the barrier member causes folds or pressure or distortion in the container that prevent fluid flow to the outlet or ambient through the valve-like passageway, absent external user-applied squeezing pressure. In another embodiment, the package includes two or more barrier members. In one aspect, a valve-like passageway is positioned between two barrier members that connects the fluid channel to the interior volume of the container.

As described above, in one embodiment, the package made in accordance with the present disclosure may include a breachable point positioned on the periphery that can be user breached for dispensing flowable substances from the package. The package can include a flexible container having an interior volume for receiving a flowable substance. The flexible container additionally defines a sealed periphery. A breachable point is located along the sealed periphery of the flexible container. The breachable point of the flexible container includes a weaker seal than the remainder of the sealed periphery.

The package further contains a fluid channel, which includes a fluid outlet and at least one valve-like passageway. The fluid outlet is located adjacent to or part of the breachable point, and the at least one valve-like passageway is in fluid communication with the interior volume of the flexible container. The package additionally includes a self-closing valve, which contains a barrier member positioned between the fluid outlet and the interior volume of the flexible container. The at least one valve-like passageway of the flexible container is formed between the barrier member and the sealed periphery. In this embodiment, intentional pressure such as a user-applied squeeze applied to the flexible container causes the breachable point to breach and dispense controlled amounts of the flowable substance from the interior volume of the flexible container. When pressure is no longer applied to the flexible container, the self-closing valve inhibits further flow of the flowable substance through the fluid outlet. This further flow is inhibited when the flexible container is spilled over on its side, dropped to the ground, or otherwise impacted after the breachable point to the ambient has been breached.

For example, the fluid channel may contain trapped air. The fluid channel can be initially free of the flowable substance and be “plump” with air or may contain residual amounts of air. In one aspect, the package is filled with the flowable substance from the bottom in order to trap air or other fluid in the fluid channel. The self-closing valve assists in keeping the fluid channel initially free of the flowable substance. A user can then breach the breachable point and dispense the substance through the fluid outlet by applying pressure to the package. For instance, the user can open the package, creating a fluid outlet, by pinching the package with a thumb and finger.

Also disclosed is a method for opening a package as defined by the present disclosure. The method includes applying pressure to the interior volume of the flexible package, causing the breachable point of the package to breach and thereby placing the fluid outlet in communication with the outside environment or ambient; and applying further pressure to the flexible container, causing the flowable substance contained within the interior volume to exit the flexible container through the self-closing valve, fluid channel and the fluid outlet.

In another embodiment, the perimeter of the flexible container can include a folded portion. The folded portion lies against an exterior surface of the flexible container and intersects with the fluid channel to block fluid flow through the channel. In one embodiment, the folded portion of the flexible container includes a folded corner of the flexible container and the folded corner forms an obtuse angle with the top edge of the flexible container. In the same embodiment, a breachable bubble is located on the folded portion extending in a direction opposite the exterior surface of the flexible container.

In one embodiment, unfolding the folded portion after the bubble is breached allows fluid to be dispensed from the interior volume through the self-closing valve and fluid channel when pressure is applied (such as squeezing by the user) to the flexible container. In one embodiment, the breachable bubble may have a recloseable attachment, fold, adhesive, static cling, or other means in order to close the bubble or the container after the bubble is breached.

In one embodiment, the flexible container includes a breachable bubble that is formed in the valve-like passageways of the fluid channel when the interior volume is filled with a fluid product.

In particular, the package of the present invention eliminates bottle caps, straws, nozzles, spray mechanisms, spouts and fitments typical of conventional liquid packaging, and instead enables one-handed opening and no-spill dispensing of fluid materials using one flexible monomer material. Thus, empty, used packages remain intact, without any loose or uncollected parts. The package of the present invention is suitable for on-the-go lifestyles with its easy to open, no-spill features while being accessible for those with disabilities such as vision impairment, impaired or limited hand strength, or arthritis, thus having improved convenience as compared to conventional liquid packaging, e.g., PET water bottles. In addition, unlike conventional water bottles, the package of the present invention may use less material, thus is lighter weight, and additionally does not require applied labels on the package.

In addition, the package of the present invention may utilize recyclable films, post-consumer recyclable films and specialty films, including bio-based, compostable polymers, enhancing both the flexibility and the sustainability of the package. The sealed polymer film package may incorporate new technologies to eliminate pathogens for each package, thereby potentially extending product shelf life of the packaged contents. The package and/or breachable bubble can further include one or more sensors, tags, electronic chips, readable codes, spectrally detectable images, scanning strips or watermarking to create “smart” packaging, thus enabling the trackability and traceability of each unique package throughout its supply chain. Thus, the package of the present invention can ensure accurate product components, ingredients, shelf life data and provide knowledge and data of the sustainability footprint of the product and package. The package material and bubble can aid in the efficiency and accuracy of package recycling, with the use of spectral and optical sorting and processing. Packages may provide sourcing data, integrated data, interoperable and aggregated data within such supply chains, including interactive consumer uses, marketing, promotions and modes, and post-consumer sorting, collection, processing and material re-uses. The breach of the bubble can enable GPS location data, time stamp, interactive data exchanges via connection to the internet of things, mobile devices, smart appliances and equipments. Such data can enable information for marketing, consumer use and/or product information or deploy or activate other proximate devices or functions. Sensors may be placed inside the bubble, embedded into the polymer film structure. Data may become dynamic when activated by sound of the “popping” of the breachable bubble or by rapid air flow, or other means.

Moreover, the package of the present invention provides the additional benefit of tamper evidence. The tamper evidence of the package can ensure that beverages and products are safe to consume by indicating if the package is sealed or if the package or has been opened prior. This can also prevent used, empty bottles and containers from being refilled with contaminated substances, thus assuring product authenticity. The package of the present invention also allows for a “self-closing” valve and flow channel within the package. This feature greatly minimizes pathogens and contaminants after opening and facilitates multi-use and re-use functionality.

Further aspects and features of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 shows a perspective view of one embodiment of the package with a sealed periphery including a breachable bubble;

FIG. 2 shows a perspective view of the package of FIG. 1 when the breachable bubble has been burst;

FIG. 3 shows a front view of the package of FIG. 1;

FIG. 4 shows a front view of yet another embodiment of the package of FIG. 1 having a generally rectangular-shaped barrier member;

FIG. 5 shows a front view of another embodiment of the package of FIG. 4 having two barrier members;

FIG. 6 shows a front view of a package according to another embodiment of the present invention having a breachable bubble separate from the fluid channel;

FIG. 7 shows a front view of a package according to FIG. 6 having a generally triangular-shaped barrier member;

FIG. 8A shows a front view of yet another embodiment of a package of the present invention having a sealing portion in a corner of the package;

FIG. 8B shows a plan view of the sealing portion of the package of FIG. 8A;

FIG. 9A shows a front view of a package according to another embodiment of the present invention having a sealing portion including two breachable bubbles;

FIG. 9B shows a partial front view of a package according to another embodiment of the present invention having a sealing portion in a corner of the package and having two breachable bubbles;

FIGS. 9C-9E show a cross-sectional view of a method of breaching the breachable bubbles in the package of FIG. 9A;

FIG. 10A shows a front view of the package of FIG. 1 placed on a flat surface;

FIG. 10B shows a side view of the package of FIG. 1 placed on a flat surface;

FIGS. 38 and 39 show another embodiment of a package made in accordance with the present disclosure;

FIG. 11 shows another embodiment of a package made in accordance with the present disclosure;

FIG. 12 shows another embodiment of a package made in accordance with the present disclosure;

FIG. 13 shows another embodiment of a package made in accordance with the present disclosure;

FIG. 14 shows another embodiment of a package made in accordance with the present disclosure;

FIG. 15 shows another embodiment of a package made in accordance with the present disclosure;

FIG. 16 shows another embodiment of a package made in accordance with the present disclosure;

FIG. 17 shows another embodiment of a package made in accordance with the present disclosure;

FIG. 18 shows another embodiment of a package made in accordance with the present disclosure;

FIG. 19 shows another embodiment of a package made in accordance with the present disclosure;

FIG. 20 shows another embodiment of a package made in accordance with the present disclosure;

FIG. 21 shows another embodiment of a package made in accordance with the present disclosure;

FIG. 22 shows another embodiment of a package made in accordance with the present disclosure;

FIG. 23 shows another embodiment of a package made in accordance with the present disclosure;

FIG. 24 shows another embodiment of a package made in accordance with the present disclosure;

FIG. 25 shows another embodiment of a package made in accordance with the present disclosure;

FIG. 26 shows another embodiment of a package made in accordance with the present disclosure;

FIG. 27 shows another embodiment of a package made in accordance with the present disclosure;

FIG. 28 shows another embodiment of a package made in accordance with the present disclosure;

FIG. 29 shows another embodiment of a package made in accordance with the present disclosure,

FIG. 30 shows another embodiment of a package made in accordance with the present disclosure;

FIG. 31 shows another embodiment of a package made in accordance with the present disclosure;

FIG. 32 shows another embodiment of a package made in accordance with the present disclosure;

FIG. 33 shows another embodiment of a package made in accordance with the present disclosure;

FIG. 34 shows another embodiment of a package made in accordance with the present disclosure;

FIG. 35 shows another embodiment of a package made in accordance with the present disclosure;

FIG. 36 shows another embodiment of a package made in accordance with the present disclosure; and

FIG. 37 shows another embodiment of a package made in accordance with the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed a multi-use, reusable, spill proof package for fluids without a removable or separable closure. In accordance with the present disclosure, the package includes a breachable point located along the sealed periphery of the flexible container and a self-closing valve. A method for opening a package according to the present disclosure is also disclosed. Because of the specific arrangement of the spill proof package, the present inventor has found that the spill proof package of the present invention substantially improves upon existing fluid bottle packaging because the package can be opened easily, without removing a cap or any material and without a separate cap ring, while the self-closing valve prevents the flowable substance within the package from spilling.

The package, in one embodiment, can be made from one or more layers of a polymer film. The walls of the package can be flexible, and the package can be integrally formed into one-piece. In the past, such packages have been relatively difficult to open. In this regard, the present disclosure is directed to a package that is not only easy to open but that can also dispense fluids in a precise and controlled manner that prevents accidental spills. In accordance with the present disclosure, the package is a one-piece, one film-type (monomaterial) package. The package has a bubble at the top of the package that can be popped to separate the layers of film and open the package. No cap, lid, or any other material needs to be removed to open the package. The bubble may provide an audible “pop” sound once the film layers are separated due to pressure on the bubble.

The package also contains a self-closing valve near the fluid channel of the container. The self-closing valve prevents fluid from spilling or leaking out of the container after the container has been opened. If no pressure is provided on the container by a user, then the self-closing valve prevents the contents of the package from escaping. When the user applies pressure to the container, such as squeezing the container, a passageway of the self-closing valve is opened and liquid can be poured from the fluid outlet of the package into the user’s mouth or into a container or control-dispensed. As such, the package provides an easy to open package which can be made simply and inexpensively, which prevents unwanted spilling of its contents. The package may be used and reused multiple times after it has been opened, transforming a single use container to a multi-use container. The package also reduces product waste and loss.

In another embodiment, the breachable bubble can be located on a folded portion of the package, such as a folded corner of the package. When the folded portion is in a folded position, the bubble is sealed from the interior volume of the package. However, after breaching the bubble, unfolding the folded portion, and applying pressure to the container, liquid in the interior volume of the package may flow through the fluid channel and the fluid outlet. In one more embodiment, the package can include two breachable bubbles with a fold between them.

In another embodiment, the flexible container of includes a breachable bubble that is formed in the valve-like passageways of the fluid channel when the interior volume is filled with a fluid product.

In one aspect, the entire package is made from a single material or polymer. By being made from a single material or polymer, the package may be formed that is completely recyclable. In addition, the package can be recycled quickly, easily and economically without having to sort materials.

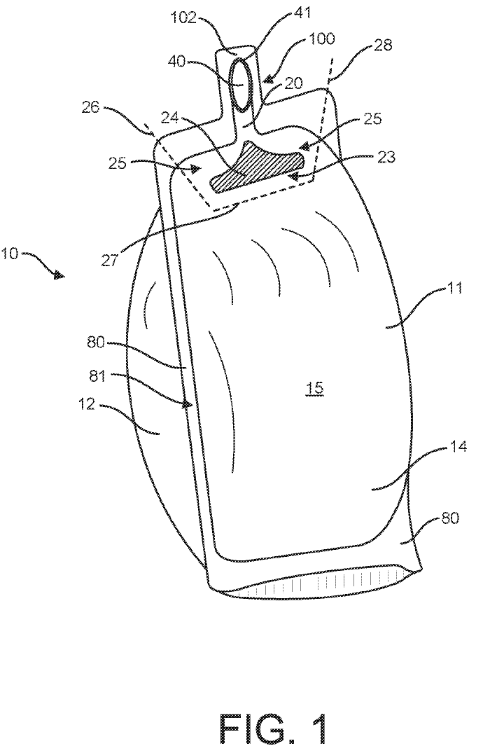

Referring to FIG. 1, reference numeral 10 generally indicates a package in accordance with one embodiment of the present invention. The package 10 may include a first film 11 and a second film 12. The first film 11 and second film 12 may, in general, be flexible polymer films. In one embodiment of the present invention, the first film 11 and the second film 12 may be portions of a singular sheet of flexible polymer film. In another embodiment, the first film 11 and the second film 12 may be separate sheets of flexible polymer film. It should be understood that the package 10 can have any suitable shape depending upon various factors including the type of product contained in or to be received in the package.

The first film 11 and the second film 12 can be made from any suitable polymer. Polymers that may be used to form the package include, for instance, polyolefins such as polyethylene and polypropylene, polyesters, polyamides, polyvinyl chloride, polylactic acid, polyhydroxyalkanoate, bio poly butylene succinate, polycaprolactone, polycarbonates, triglycerides, cellulose polymers, mixtures thereof, copolymers thereof, terpolymers thereof, and the like. In addition, the package can also be made from any suitable elastomeric polymer. It should be understood, however, that the first film 11 and the second film 12 are not limited to flexible polymer films but may be any suitable films. For example, the first film 11 and second film 12 may be formed from a metallized film, laminated paper, cellulose, plant-based or bio-based, biodegradable, bio compostable film or the like.

The first film 11 and the second film 12 can each comprise a single layer of material or can include multiple layers and can include coatings or additives. For instance, the first film 11 and the second film 12 can each include a core layer of polymeric material coated on one or both sides with other functional polymeric layers. The other functional polymeric layers may include, for instance, an oxygen barrier member layer, an ultraviolet filter layer, an anti-blocking layer, a printed layer, and the like.

The first film 11 and the second film 12 can each be translucent or transparent. If translucent or transparent, for instance, the contents of the package 10 can be viewed from the outside. In another embodiment, however, the first film 11 and the second film 12 can each be opaque For instance, in one embodiment, the package 10 can display various graphics that identify, for instance, the brand and the description of the product inside, or that display coupons or incorporate sensors, tags or various other indicia. In other embodiments, the first film 11 can be translucent or transparent while the second film 12 is opaque, and the first film 11 can be opaque while the second film 12 is translucent or transparent.

In accordance with the present disclosure, the first film 11 and the second film 12 may be sealed together to form a flexible container 14. The first film 11 and the second film 12 may be sealed or welded together using any suitable sealing technique, such as an adhesive or polymer or nanomolecular bonding process.

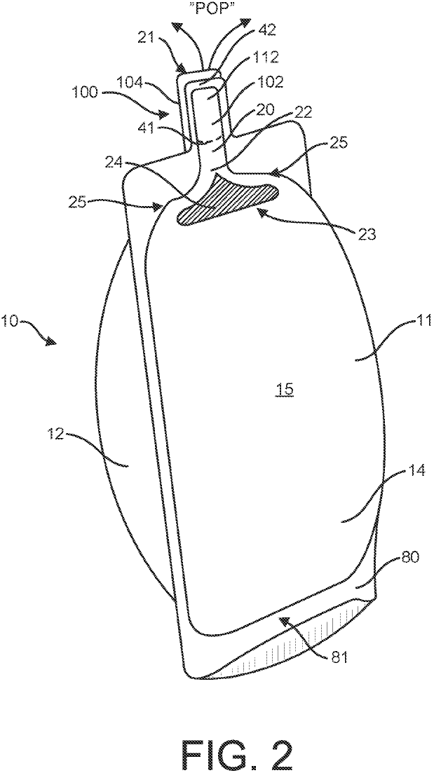

The flexible container 14 may define an interior volume 15, shown in FIG. 2, configured to receive a fluid product, e.g. a liquid. The portion of the first film 11 and the second film 12 which lies outside the perimeter of the sealed interior volume 15 may define a package periphery 80 defined by a seal 81. In one embodiment, a product may be situated in the interior volume 15. The product may, in some embodiments, be a beverage, such as water. In one embodiment, for example, the fluid product may include a beverage, a gel, a cream, a paste, a syrup, a honey, an oil, a sauce, a lubricant, or a grease. In some embodiments, the product may include an emulsion, such as a mayonnaise. In some embodiments, the product may include any other liquid or flowable substance.

As best shown in FIGS. 1-5, the package contains a fluid channel 20. The fluid channel 20 is connected to a fluid outlet 21 at a first end and to the interior volume 15 of the flexible container 14 at a second end 22. A self-closing valve 23 is positioned at the second end 22 of the fluid channel 20 to prevent undesired spillage of the product 16.

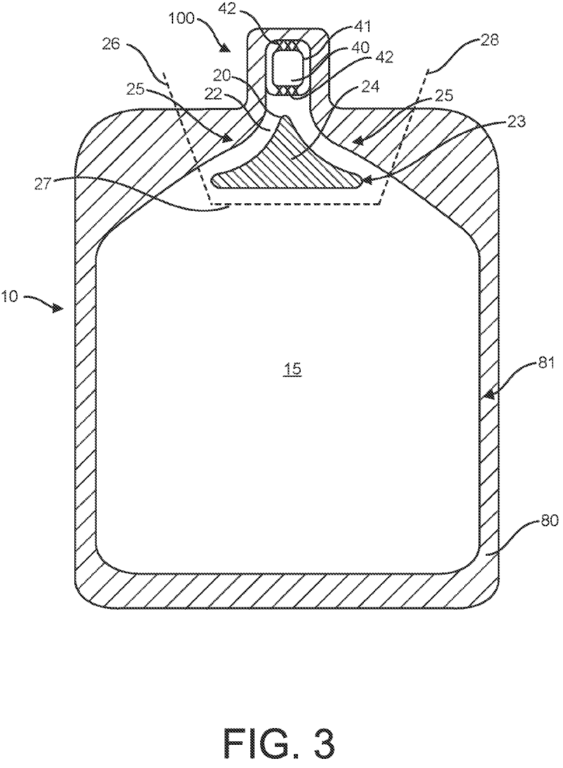

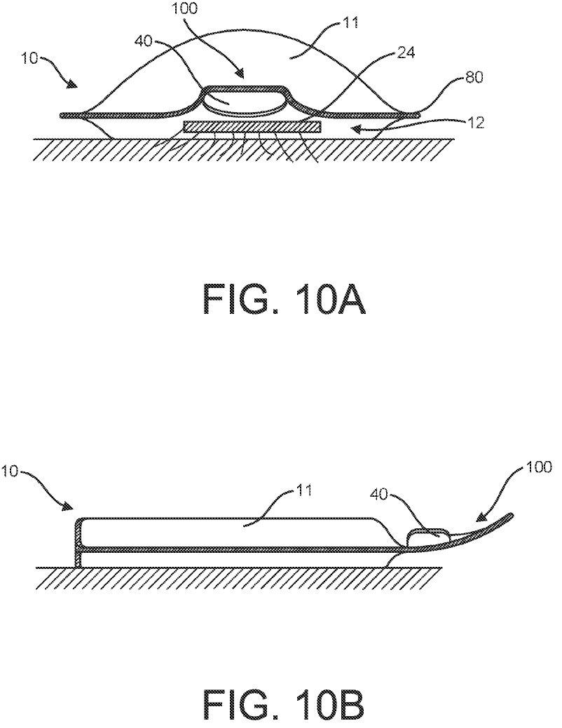

In one embodiment, the self-closing valve 23 includes a barrier member 24, as shown in FIGS. 1-5. The barrier member may be formed by welding or gluing the first flexible film 11 and the second flexible film 12 together at a location near the second end 22 of the fluid channel 20. The barrier member 24 may be elongated in shape and is transverse to the second end 22 of the fluid channel 20. In one embodiment, as best seen in FIGS. 3-5, the barrier member 24 has a length greater than the width of the fluid channel 20. Preferably the length of the barrier member 24 is only slightly longer than the width of the fluid channel 20, such as from about 1 mm to about 10 mm longer. This creates at least one valve-like passageway 25 between the barrier member 24 and an edge of the fluid channel 20. The barrier member 24 may allow a valve-like passageway 25 on each side of the fluid channel 20 as shown in FIGS. 1-5. Alternatively, the barrier member 24 may extend all the way to the package periphery 80 on one side, only allowing a single valve-like passageway 25 between the interior volume 15 and the fluid channel 20. The at least one valve-like passageway 25 has a curved shape determined by the shape of the space between the barrier member 24 and the seal 80 of the container 14. The curved shape of the passageway 25 is configured to prevent the flow of fluid through the passageway 25 unless the container 14 is squeezed to cause fluid pressure. Preferably, the barrier member 24 extends approximately perpendicular to the general direction of the fluid channel 20. The barrier member 24 may be shaped in a way such that the sealing portion 100 of the container arches upward, as shown in FIGS. 10A-10B, in order to provide a better seal.

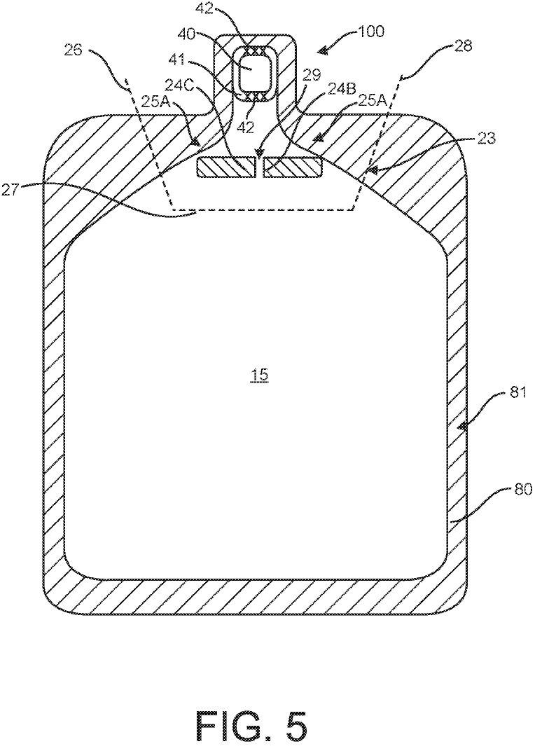

The self-closing valve 23 of package 10 of FIGS. 1-2 includes one barrier member 24. However, in at least one other embodiment such as the package 10 as illustrated in FIG. 5, a package 10 according to the present disclosure may include two or more barrier members.

The fluid channel 20 may have a width of, for example, between 5 mm and 20 mm or any range or value therebetween, preferably between 10 mm and 15 mm, such as about 12 mm. However, the fluid channel 20 may have any desirable width, depending on the application of the container 14.

As illustrated in FIGS. 1-2, when the interior volume 15 of the flexible container 14 is filled with product, the first flexible film 11 and the second flexible film 12 are spaced apart from each other within the flexible container 14. The separation of the first flexible film 11 and the second flexible film 12 may create folds across the at least one valve-like passageway 25. As shown in FIGS. 1-5, fold lines 26, 27 and 28 are present across from the valve-like passageways on each side of the barrier member 24. The folds extend along the axes marked by dashed lines 26, 27 and 28. It should be understood, however, that the fold lines 26, 27, and 28 are representative of the approximate axes of the actual folds in the self-closing valve 23, but they may not be clearly visible from the surface of the package 10.

The folds 26, 27, and 28, as well as the barrier member 24 extending across the fluid channel 20 opening cause a portion of the periphery of the package 80 including the sealing portion 100 to curve inward (arch). The arching of the zone between the folds, that includes the fluid channel 20, has the effect of pressing the two flexible films 11 and 12 in this zone against each other, thus forming a self-closing valve 23 that blocks the flow of the liquid through the valve-like passages 25 and through the fluid channel 20.

As illustrated in FIGS. 10A-10B, when the package is placed on a flat surface and a vertical force is applied approximately on the large central portion of the flexible container 14 in the center of the front and back package walls, then the folds 26, 27, and 28 and the arching effect of the zone between the folds that includes the fluid passage 20, tends to become more pronounced, thus increasing the effectiveness of the self-closing valve 23.

Such accentuation of the folds close to the valve-like passages 25 as well as the increase in the arching of the zone between the folds with the application of a force essentially perpendicular to the plane of the flexible walls of the package 10, effectively prevents liquid leakages when the flexible package 10 is placed in its natural position on an essentially flat surface. Even when another object is placed on the top of the flexible package 10 or moderate pressure is applied to the center of the package 10 by a user, increasing the pressure in the interior volume 15, the self-closing valve 23 maintains its integrity. Such a mechanism is extremely helpful in preventing accidental spillage.

In order to allow the flow of liquid through the valve-like passages 25 and through the fluid channel 20 and outlet 21, it is sufficient that a user applies a certain pressure to the flexible container 14, in particular by squeezing it, at least in part, in a direction essentially perpendicular to the plane of the barrier member 24, thus partially opening the lips which close off the valve-like passages 25. The release of this squeezing action re-closes the shrunken passages 25 and re-closes the container 14. Essentially, in order to eject the liquid product from the interior volume 15, the user needs to squeeze the container from the sides, and when the user removes pressure from the sides, the container 14 re-closes.

The squeezing of the container 14 from the sides, essentially perpendicular to the plane of the barrier member, has the effect of reducing the arching and the folds, while at the same time increasing the pressure of the liquid in the container 14, which then causes the lips of the flexible sheets at the entrance of the valve-like passages 25 to partially open, allowing the liquid to flow out. The fluid channel in the outlet can be designed so that a liquid can flow out of the container 14 in different ways. For example, in one embodiment, the fluid can flow in a single channel and form a single stream. Alternatively, the package can be designed so that the fluid exits the container 14 in a spray pattern. For example, in one embodiment, the outlet may include a plurality of channels.

The advantages to the described and depicted self-closing valve 23 are that it is extremely simple to form and the operation of the valve 23 is less dependent on the properties of the fluid and the elasticity of the material constituting the container 14 than in other types of flexible containers.

In some embodiments, for example as shown in FIGS. 1-3, the barrier member 24 is located opposite the second end 22 of the fluid channel 20 and has a generally triangular shape. In this embodiment, a side of the generally triangular shaped barrier member 24 that is distal to the fluid channel 20 can have a length wider than a width of the fluid channel 20 and can extend approximately perpendicular to a general direction of the fluid channel 20. The valve-like passages 25 can extend between the package periphery 80 and two respective sides of the generally triangular barrier member 24 positioned nearest to the second end 22 of the fluid channel 20. The two respective sides of the generally triangular barrier member 24 that form the valve-like passages 25 can include a concave curvature, as shown in FIG. 3, resulting in curved passageways 25, or can extend in a straight line. The point of the generally triangular shaped barrier member 24 that is nearest to the second end 22 of the fluid channel 20 can extend into the fluid channel 20, as shown in FIG. 3.

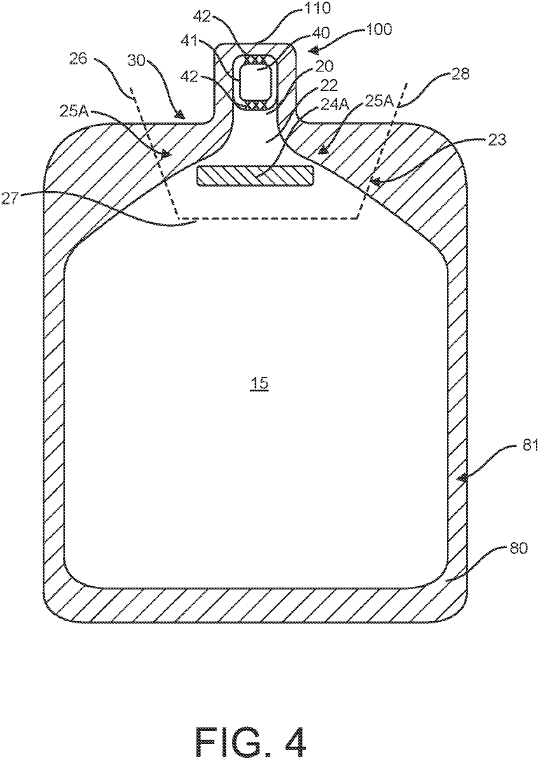

Alternatively, as shown in FIG. 4, a barrier member 24A can be located opposite the second end 22 of the fluid channel 20 and have a generally rectangular shape. In this embodiment, a side of the generally rectangular shaped barrier member 24 that is distal to the fluid channel 20 can have a length wider than a width of the fluid channel 20 and can extend approximately perpendicular to a general direction of the fluid channel 20. The valve-like passages 25A can extend between the package periphery 80 and two respective sides of the generally rectangular barrier member 24A positioned nearest to the second end 22 of the fluid channel 20.

In another embodiment, shown in FIG. 5, the barrier member is located opposite the second end 22 of the fluid channel 20 as in FIGS. 3-4, except that the barrier member includes two barrier members, shown as 24B and 24C, and has with a central passage 29. In this embodiment, the central passage 29 created between the two barrier members 24B and 24C allows the flow of the liquid in the fluid channel 20 to be increased when the user applies pressure to the container 14 in a direction essentially perpendicular to the plane of the barrier member 24, as previously described.

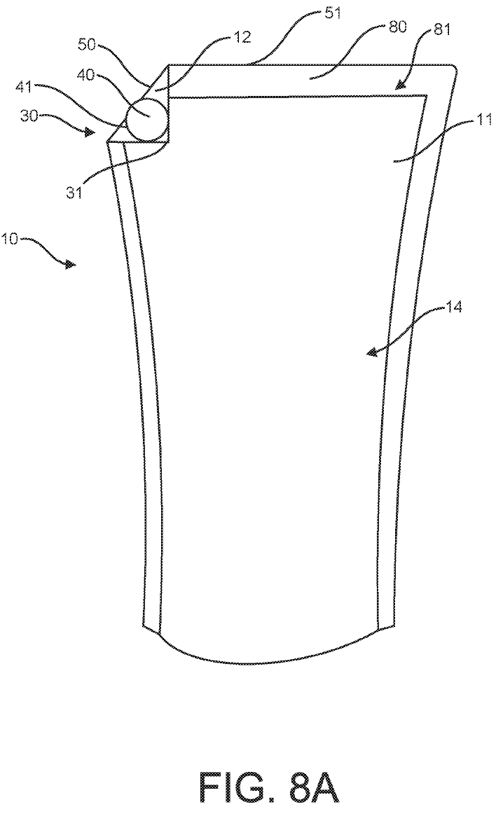

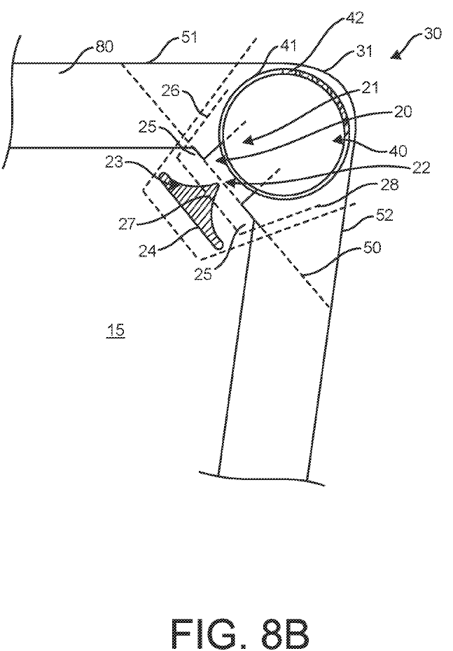

In another alternative embodiment, as shown in FIGS. 8A-8B, the sealing portion 100 is positioned at a corner of the container 14 and contains a folded portion 30. In one embodiment, the corner 31 of the container 14 contained by the folded corner 30 forms an acute angle. For example, the corner 31 of the container may form an angle between about 60° and about 88°. The angle of corner 31 is defined as the angle between the top edge 51 of the package and the portion of side edge 52 of the container 14, shown in FIGS. 8A-8B, which lies on folded portion 30. Such an angled corner allows for the optimum direction of the forces pertaining to the folding and unfolding of the folds 26, 27, and 28 and the arching of the zone between folds leading to a higher integrity seal when lying flat in its natural position, and better flow when squeezed from the sides.

As shown in FIGS. 1-5, the external sealing portion 100 may include a breachable bubble 40. The breachable bubble 40 is surrounded by and defined by a bubble seal 41 that is at least partially breachable. For example, the bubble seal 41 can include at least one breachable point 42. The breachable point 42 represents a portion of the bubble seal 41 that more easily separates than the remainder of the seal, for example, a weak spot or a soft seal. In one embodiment, the breachable point 42 is positioned at a position on the bubble seal 41 that is distant from the self-closing valve 23, such as the furthest point on the bubble seal 41 from the self-closing valve 23.

In another embodiment, the breachable bubble 40 can have two breachable points 42, one that is distant from the self-closing valve 23 and one that is adjacent to the self-closing valve 23, as shown in FIG. 3. One breachable point 42 may be breached by bursting the bubble 40, e.g., by squeezing the bubble 40. After one breachable point 42 has been breached, the second breachable point 42 may be breached, e.g., by squeezing the container 14 from the sides until the fluid product in the interior volume 15 passes through the channels 25 and generates sufficient pressure against the second breachable point 42 to breach the second breachable point 42.

A breachable point 42 can coincide with the boundary 110 of the external sealing portion 100. Furthermore, the breachable point 42 may be designed to provide the user an access or passageway upon the breach or bursting of the bubble 40. The access or passageway may be exposed when the gas trapped within the bubble escapes as the breachable bubble 42 is breached. When the bubble 40 includes only one breachable point 42, the access or passageway may assist the user to grip the front sealing surface 102 and back sealing surface 104 when unfolding the external sealing portion 100. As shown in FIG. 2, the access or passageway provided by the breachable point 42 may be embodied by a portion of the front sealing surface 102 designated as a pull tab 81.

In one embodiment, the external sealing portion 100 may be positioned such that the fluid channel 20 lies between the front sealing surface 102 and the rear sealing surface 104. The front sealing surface 102 of the first flexible film 11 attaches to the rear sealing surface 104 of the second flexible film 12. The front sealing surface 102 and the rear sealing surface 104 can be attached by way of a resealable or permanent attachment method, such as sealing or welding the surfaces together using any suitable sealing technique, for example an adhesive. A breachable bubble 40 is located within the front sealing surface 102. The bubble seal 41 coincides with the boundary 110 at a breachable point or weak spot 42.

In one embodiment, the external sealing portion 100 may be unfolded or peeled open as shown in FIG. 2. The front and rear sealing surfaces 102 and 104 can be peeled apart to separate a lower edge of the bubble seal 41 to permit access to the fluid outlet 21. The front and rear sealing surfaces 102 and 104 may remain connected to each other at sides or may be fully separated.

In an alternative embodiment, the breachable bubble 40 of the external sealing portion 100 can be breached at a breachable point 42 within the boundary 110, and the breachable bubble 40 can have an additional breachable point 42 adjacent to the fluid channel 20. In this embodiment, when the bubble 40 is breached, an access or passageway is opened at the breachable point 42 within the boundary 110. Then, the breachable point 42 near the fluid channel 20 is opened by squeezing the container 14 until the fluid pressure of the liquid 16 within the container 14 bursts the second breachable point 42, thus forming a spout for the fluid outlet 21.

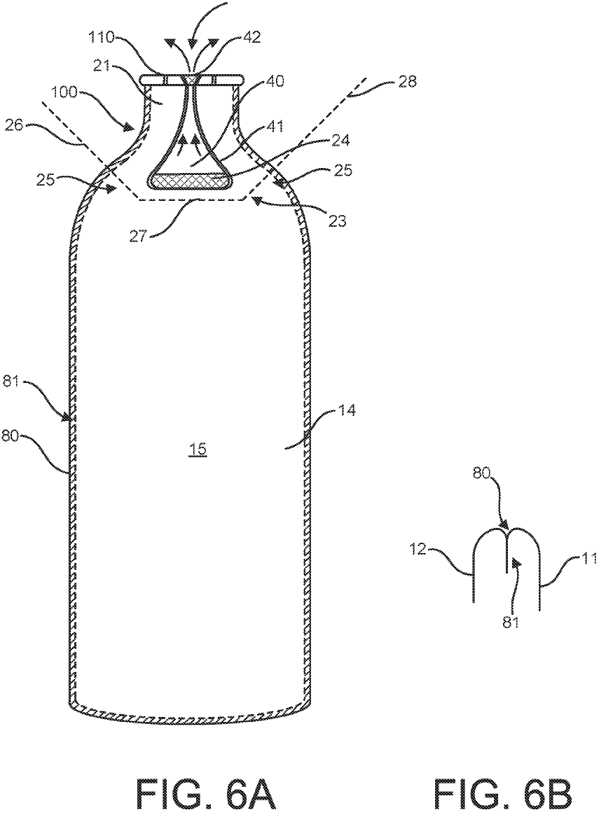

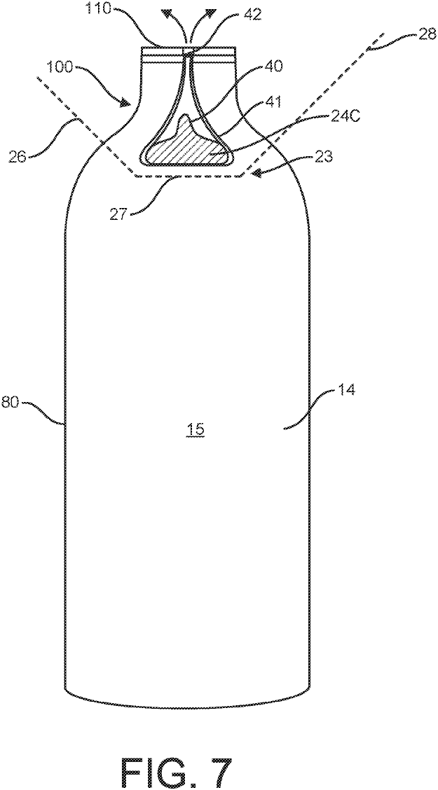

In another embodiment, as shown in FIGS. 6A and 7, the container 14 generally contains a breachable bubble 40 having a bubble seal 41 in communication with the barrier member 24. In this embodiment, the fluid channel 20 surrounds the breachable bubble 40 but the breachable bubble 40 is not in fluid communication with the fluid channel 20. The breachable bubble 40 can include a breachable point 42 in the form of a weak spot or soft seal integrated with the boundary 110 of the external sealing portion 100 such that, when the breachable bubble 40 bursts, the soft seal 42 is breached toward the boundary 110 and provides an access or passageway to the front sealing surface 102 and the rear sealing surface 104. Then, the front sealing surface 102 and the rear sealing surface 104 may be peeled away from each other to reveal the fluid opening 21, allowing for unimpeded flow of liquid 15 from the fluid channel 20 to the ambient.

In addition, the container 14 shown in FIG. 6A has a rounded periphery 80 formed by an inverted seal 81. Stated another way, in contrast to the edge seal 81 shown in FIGS. 1-5, the container 14 shown in FIGS. 6A-B has a seal 81 disposed in the interior 15 of the container 14 such that the periphery 80 is rounded and has no linear or sharp edges of film material. The container 14 of FIG. 6A can be formed by bonding the first film 11 and second film 12 together along the seam 81 and inverting the first film 11 and second film 12 inside-out to form the container 14 having a rounded periphery 80 as shown in FIG. 6B.

In a preferred embodiment, the container 14 only contains a single breachable bubble 40. Additionally, it is preferable that the breachable bubble 40 only protrudes or projects from one side of the package 14. In some embodiments, such as the embodiment shown in FIGS. 8A-8B, this preference minimizes interference with the adherence of the folded portion 30 to the exterior of the flexible container 14. As such, the bubble 40 preferably only projects from the front sealing surface 102 of the sealing portion 100 opposite the rear sealing surface 104 of the flexible container 14.

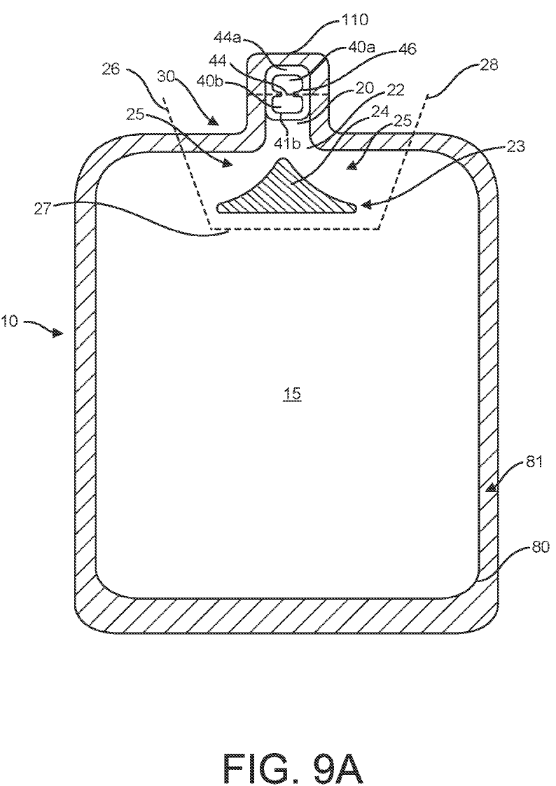

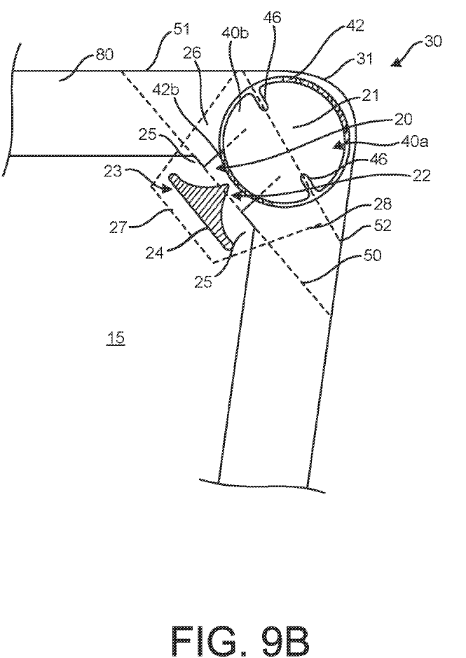

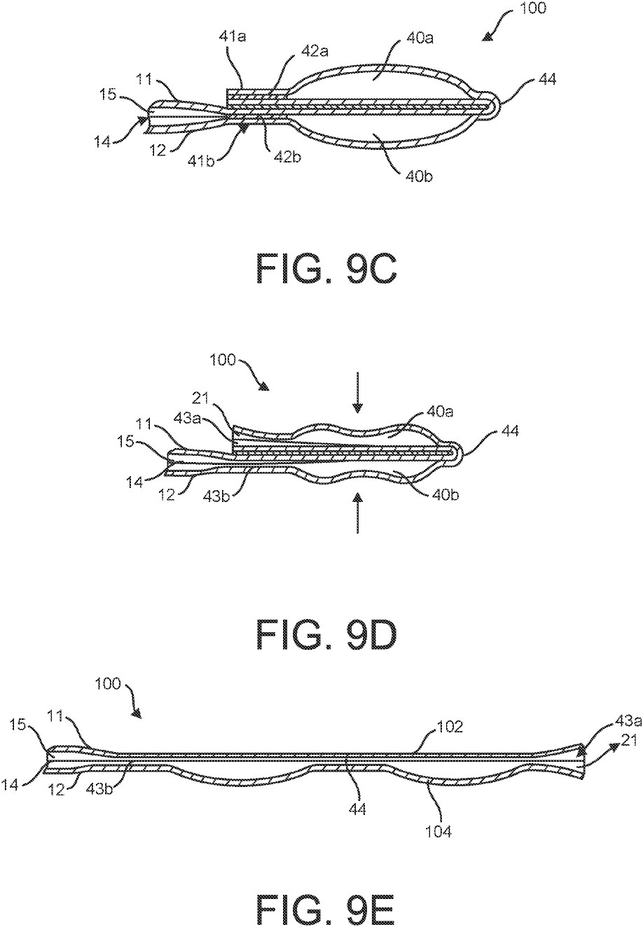

Alternatively, as shown in FIGS. 9A-9E, the sealing portion 100 of the container 14 can include two breachable bubbles 40a and 40b. The two breachable bubbles 40a and 40b can optionally be formed by folding a single breachable bubble 40 into two halves, as shown in FIGS. 9C-9D. As best illustrated in FIGS. 9A-9B, the sealing portion 100 can include folding barrier members 46 to assist with folding the breachable bubble 40 into two bubbles 40a and 40b. The breachable bubble 40a can have a bubble seal 41a within the boundary 110 of the external sealing portion 100, and the breachable bubble 40b can have a bubble seal 41b adjacent to the fluid channel 20 of the container 14. As best shown in FIG. 9B, both bubble seals 41a and 41b can include a breachable point 42a and 42b, respectively. Thus, as shown in FIG. 9D, the breachable point 42a can burst the bubble 40a to open toward the exterior of the package 10 to form an opening 43a, and breachable point 42b can be breached to open toward the interior volume 15 of the package 10 to form an opening 43b. As shown in FIG. 9E, when the sealing portion 100 is unfolded, the sealing portion 100 becomes part of the fluid channel 20 such that the opening 43a forms the fluid outlet 21.

Optionally, the breachable bubbles 40a and 40b can have a passage 44 between them. The passage 44 can advantageously control the flow of the product through the breachable bubbles 40a and 40b when they have been breached. For example, as shown in FIGS. 9C-D, when the sealing portion 100 is folded at the passage 44, no product can flow from bubble 40b into bubble 40a and to the fluid outlet 21. For example, in various embodiments as shown in FIGS. 9A-9E, the passage 44 may be a substantially straight passage between the first breachable bubble 40a and the second breachable bubble 40b. The width of the passage 44 may vary depending on the desired flow characteristics of the fluid. Alternatively, the passage 44 may be a circuitous or serpentine passage between first breachable bubble 40a and the second breachable bubble 40b. Both the width of the passage 44 and the circuitous or serpentine path of the passage 44 may vary depending on the desired flow characteristics of the fluid. In other alternative embodiments, the passage 44 may be a tapered passage.

The bubble seal 41 can be made using various techniques and methods. For instance, the bubble seal 41 can be made using thermal bonding, ultrasonic bonding, or an adhesive. For instance, in one particular embodiment, the bubble seal 41 can be made by placing a heated sealing bar against the outer periphery of the bubble and exerting heat and pressure so as to form the breachable bubble 40. In this embodiment, for instance, the breachable bubble 40 can be made from polymer films.

The breachable point 42 of the bubble seal 41 can also be made using different techniques and methods. When using a sealing bar to form the bubble seal 41, for instance, the breachable point 42 can be constructed by varying the pressure, varying the temperature, or varying the time in which the sealing bar is contacted with the materials along the portion of the bubble seal 41 where the breachable point 42 is to exist.

In an alternative embodiment, the bubble seal 41 can include a heat sealed portion. The breachable point 42, on the other hand, may include a “peel seal” portion. In this embodiment, for instance, when the breachable bubble 40 is breached along the breachable point 42, a small opening may be formed along the bubble seal 41. The breached portion of the bubble seal 41 can form at least one, e.g. two, tabs 102 and 104 that can be grasped by a user for further breaching the breachable bubble 40. In this manner, the opening of the bubble can be increased in size to a user’s preference. An example of tabs formed by the breaching of the breachable bubble 40 is shown in FIG. 2.

Various different methods and techniques are used to form peel seal portions. For example, in one embodiment, the breachable point 42 of the bubble seal 41 may include a first portion that is adhesively secured to a second portion along the seal 41. The first portion of the breachable point 42 may be coated with a pressure sensitive adhesive. The adhesive may include, for instance, any suitable adhesive, such as an acrylate. The second and opposing portion of the peel seal, on the other hand, may include a film coated or laminated to a release layer. The release layer may include, for instance, a silicone.

In an alternative embodiment, each opposing portion of the breachable point 42 of the bubble seal 41 may include a multi-layered film. The major layers of the film may include a supporting layer, a pressure sensitive adhesive component, and a thin contact layer. In this embodiment, the two portions of the breachable point 42 can be brought together and attached. For instance, the thin contact layer of one portion can be attached to the thin contact layer of the opposing portion using heat and/or pressure. When the breachable bubble 40 is breached, and the breachable point 42 of the bubble seal 41 is peeled apart, a part of the sealed area of one of the contact layers tears away from its pressure sensitive adhesive component and remains adhered to the opposing contact layer. Thereafter, resealing can be affected by re-engaging this torn away contact portion with the pressure sensitive adhesive from which it was separated when the layers were peeled apart.

In this embodiment, the contact layer can include a film having a relatively low tensile strength and having a relatively low elongation at break. Examples of such materials include polyolefins such as polyethylenes, copolymers of ethylene and ethylenically unsaturated comonomers, copolymers of an olefin and an ethylenically unsaturated monocarboxylic acid, and the like. The pressure sensitive adhesive contained within the layers, on the other hand, may be of the hot-melt variety or otherwise responsive to heat and/or pressure.

In still another embodiment, the breachable point 42 of the bubble seal 41 can include a combination of heat sealing and adhesive sealing. For instance, in one embodiment, the breachable point 42 may include a first portion that is heat sealed to a second portion. Along the breachable point 42, however, may also exist a peel seal composition that may, in one embodiment, interfere with the heat sealing process of the bubble seal 41 to produce a breachable portion 42. The peel seal composition, for instance, may include a lacquer that forms a weak portion along the bubble seal 41.

In an alternative embodiment, an adhesive may be spot coated over the length of the breachable point 42. Once the breachable point 42 is breached, the adhesive can then be used to reseal the two portions together after use.

In embodiments where the breachable bubble 40 and sealing portion 100 are re-sealable, the container 14 may be re-closed to provide a more robust seal than by relying on the self-closing valve 23 alone.

The breachable bubble 40 can be filled with a gas, such as air. The breachable bubble may also be filled with any other fluid, such as a liquid, in addition to air or gas. In some embodiments, as shown in FIGS. 1-5, the interior volume of the breachable bubble 40 can be generally in fluid communication with the fluid channel 20. The gas pressure within the bubble can be sufficient so as to prevent the contents of the container from exiting through the fluid channel 20 until the breachable bubble 40 is breached. As such, prior to breaching of the breachable bubble 40, the fluid within the interior volume of the container 14 is prevented from escaping into the breachable bubble 40 by both the self-closing valve 23 and the gas pressure within the bubble 40. It is additionally prevented from escaping into the ambient by the bubble seal 42.

The breachable bubble 40, as described above, is expandable to open the container 14 by external pressure applied by a consumer. For small bubbles, the consumer may simply pinch a bubble or bubbles between his thumb and forefinger. Slightly larger bubbles may require thumb-to-thumb pressure. Pressure can also be applied to the bubble by placing the bubble against a flat surface and applying pressure with one’s fingers or palm.

When pressure is applied to the breachable bubble 40, the atmosphere within the bubble applies pressure to the bubble seal 41 which causes the bubble 40 to breach at the weakest portion. For instance, in embodiments that include a breachable point 42, separation of the bubble 40 occurs along the breachable point 42 creating an edge breach. In some embodiments, the edge breach may be sufficient to allow access to the fluid channel 20 for dispensing the contents of the container. Alternatively, the edge breach may form flaps 81 and 82 that can be easily peeled apart for better exposing the fluid channel 20. FIG. 2 shows the breachable bubble 40 after it has been breached.

The breachable bubble 40 may provide a distinct breaching sound when the bubble 40 is breached. The breaching sound may be caused by the trapped fluid escaping from the front and rear sealing surfaces 102 and 104 when the breachable bubble 40 is breached. For example, in one embodiment, the breachable bubble 40 may provide a popping sound, similar to a small balloon popping, when the breachable bubble 40 is breached. In other embodiments, the breachable bubble 40 may provide, for example, a peeping sound, a snapping sound, or a whistling sound.

In the embodiments illustrated, the breachable bubble 40 has a circular shape. It should be understood, however, that the breachable bubble 40 can have any suitable shape. For example, in other embodiments, the breachable bubble 40 may have an oval shape, may be triangular, may have a heart-like shape, may have a rectangular-like shape, or may have a more complex configuration. It should be understood that containers made according to the present disclosure can have any suitable shape and configuration.

A method for opening the package is also disclosed. A user may open a package as shown in FIG. 1 with the external sealing portion 100 according to the following method. First, the user bursts the breachable bubble 40, preferably by breaching the breachable point 42. Second, the breaching of the breachable point 42 allows the user to access the pull tabs 81 and 82. Third, by use of the pull tab, the user peels the front sealing surface 102 of the first flexible film 11 apart from the rear sealing surface 104 of the second flexible film 12. Fourth, the user continues to peel the sealing surfaces 102 and 104 apart until the entire bubble seal 41 is breached. When the bubble seal 41 is breached to a sufficient extent to expose the fluid outlet 21, the fluid outlet 21 is granted fluid communication with the ambient atmosphere, allowing the user to access the contents within the interior volume 15 by way of the fluid channel 20 and the self-closing valve 23. Optionally, the user may fold back the first sealing surface 102 for more convenient access to the fluid outlet 21.

Alternatively, when the sealing portion 100 includes a single breachable bubble 40 having two breachable points 42 as shown in, e.g., FIG. 3, the user bursts the breachable bubble 40 by breaching the breachable point 42 within the boundary 110 of the sealing portion 100 and furthest from the self-closing valve 23. After the first breachable point 42 has been breached, the user can squeeze the package 10 to increase the pressure of the liquid contents against the second breachable point 42 near to the self-closing valve 23 until the second breachable point 42 is breached by the liquid. Thus, when both breachable points 42 have been breached, a fluid outlet 21 is formed, granting fluid communication with the ambient atmosphere, allowing the user to access the contents within the interior volume 15 by way of the fluid channel 20 and the self-closing valve 23.

In another embodiment, when the sealing portion 100 includes a folded portion on a corner of the container 14, the method may be carried out as follows. First, the package 10 is configured so that the folded portion 30 is in the folded position, cutting off fluid flow between the breachable bubble 40 and the interior volume 15 of the package. This is shown in FIG. 8A. Next, a user applies sufficient pressure to the breachable bubble 40 in order to breach the bubble seal 42 and separate first flexible film 11 from second flexible film 12. Preferably, the user applies pressure on the section of the bubble 40 closest to the fold line 50.

After the bubble is breached, the user unfolds the folded portion 30 from the folded position to the unfolded position, as shown in FIG. 8B. This allows fluid communication between the ambient and the self-closing valve 23. The user may have to further separate the two tabs 81 and 82 formed by the breaching of the bubble in order to expose the fluid outlet 21.

In yet another embodiment, when the sealing portion 100 includes two breachable bubbles 40a and 40b folded over each other, as shown in FIG. 9C, the method may be carried out as follows and as illustrated in FIGS. 9D-9E. First, the package 10 is configured so that the bubble 40a is folded over the bubble 40b, cutting off any fluid flow between the bubbles 40a and 40b, as shown in FIG. 9C. Next, a user applies sufficient pressure to the breachable bubbles 40a and 40b in order to breach the breachable points 42a and 42b to form openings 43a and 43b, as shown in FIG. 9D. After the bubbles 42a and 42b are breached, the user unfolds the sealing portion 100 to the unfolded position shown in FIG. 9E. This allows fluid communication between the ambient and the self-closing valve 23. Then, fluid may exit through the fluid outlet 21 of the package 10.

In any embodiment, the self-closing valve 23 prevents unwanted fluid flow. For example, as the package 10 is opened and the sealing portion 100 is unfolded or peeled open, the self-closing valve 23 prevents the contents of the interior volume 15 to escape. Further, even if the fluid channel 20 is pointed downward toward the ground, the contents of the package 10 are still unable to escape even if the user supplies a moderate amount of pressure to the center of the front 11 and back 12 walls of the package 10. This is due to the barrier member 24 and the folds 26, 27, and 28 created by the self-closing valve 23 and pressure, as described above.

When desired, in order to allow the liquid contained in the container 14 to pour out through the fluid channel 20 and fluid outlet 21, pressure is applied to the sides of the package 10 perpendicular to the plane of the barrier member 24. The shape of the fluid channel 20 and fluid outlet 21 may be shaped in any manner in order to influence the flow properties as the fluid is poured out of the package. As such, the package allows for a precise, controlled flow, unlike many similar flexible liquid packages or pouches.

When the user wants to stop the flow of the liquid, they may simply stop applying pressure to the sides of the container 14 and the self-closing valve 23 will close back up, preventing further flow. In this manner, the user does not need to reposition the container 14 in an upright position in order to stop flow.

Referring to FIGS. 11-39, various other embodiments of packages made in accordance with the present disclosure are shown. In each of these embodiments, the breachable bubble can be integrated into the self-closing valve design. The bubble can be breached for forming a passageway between the interior volume and the outside environment (i.e. outside the package). Breaching the bubble also activates the self-closing valve for a controlled dispensing of a product contained within the package.

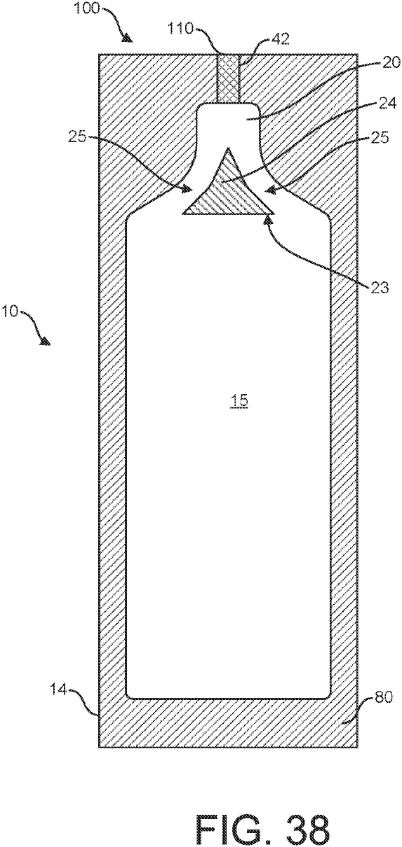

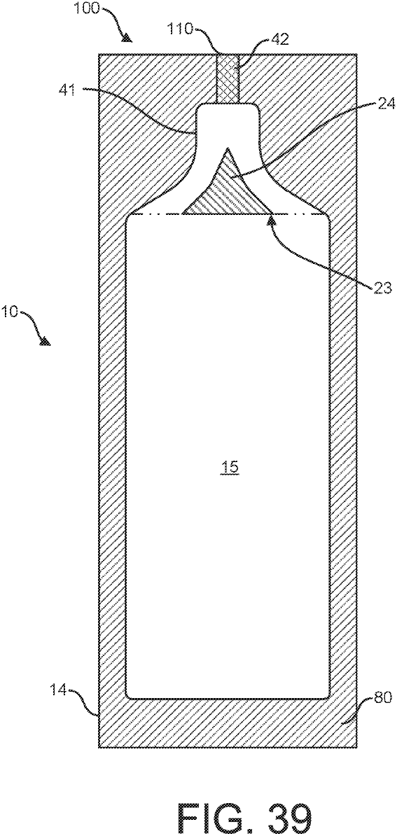

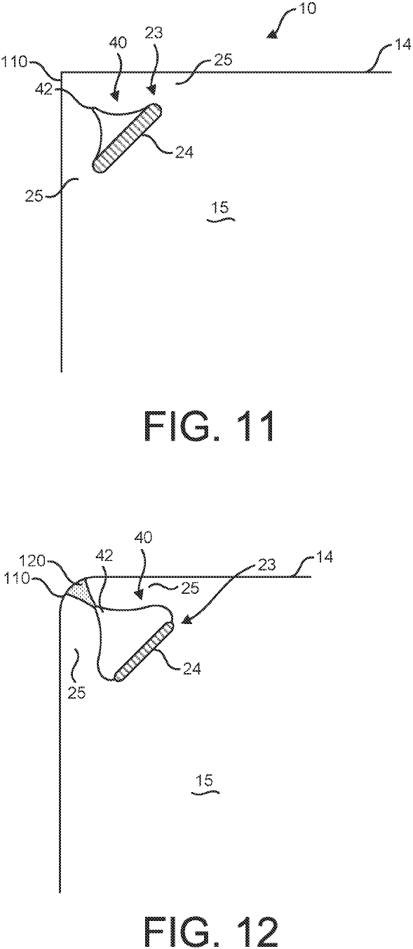

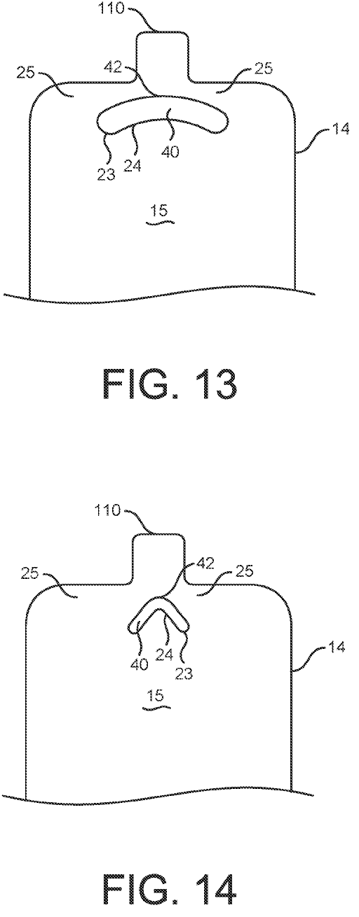

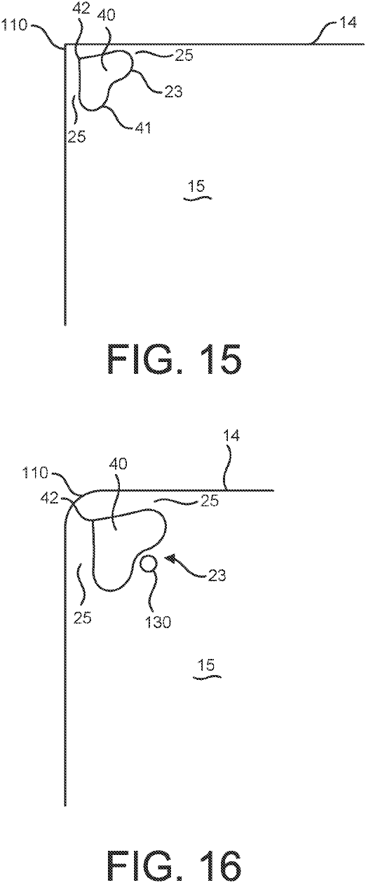

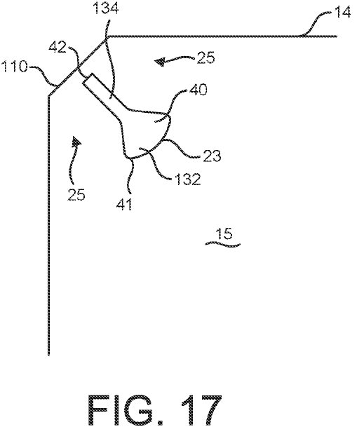

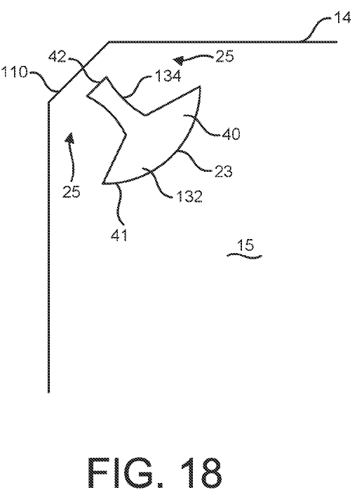

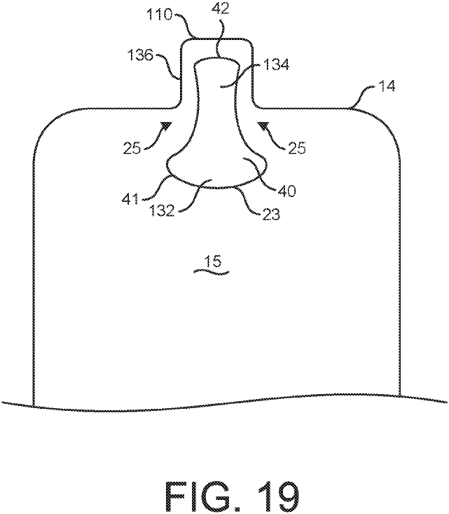

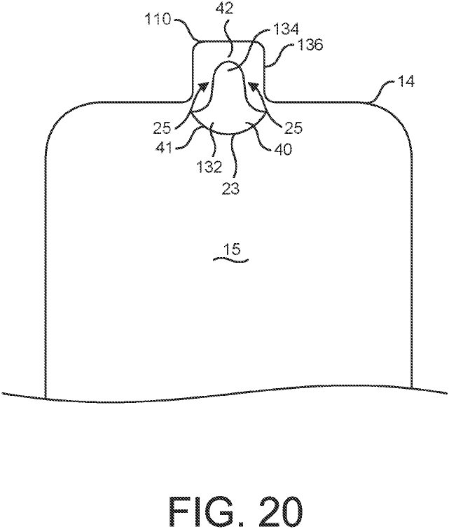

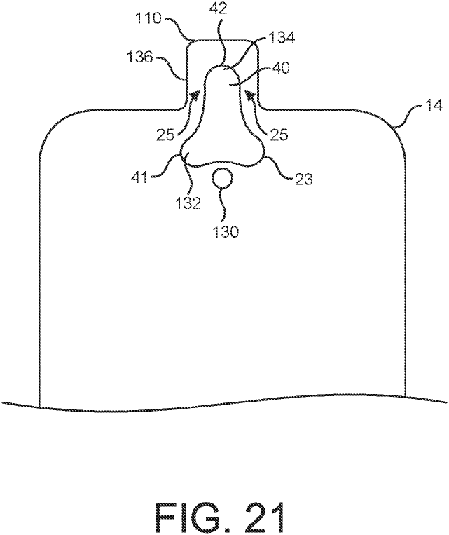

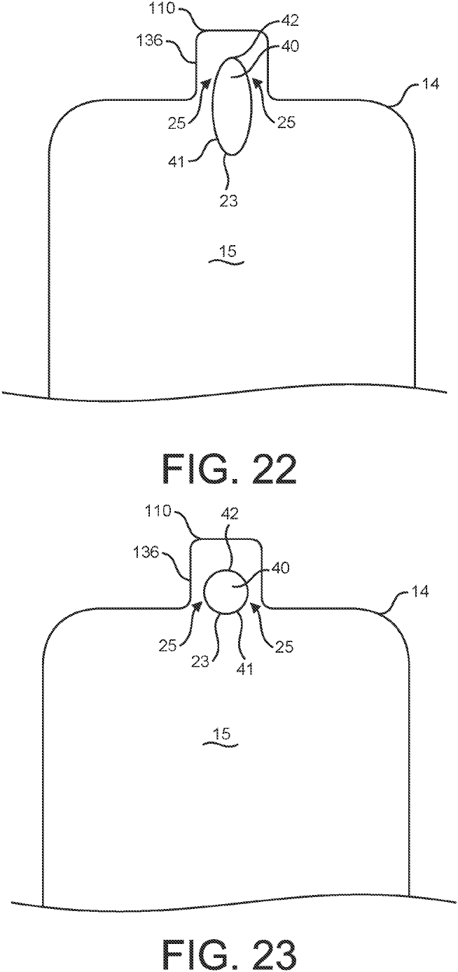

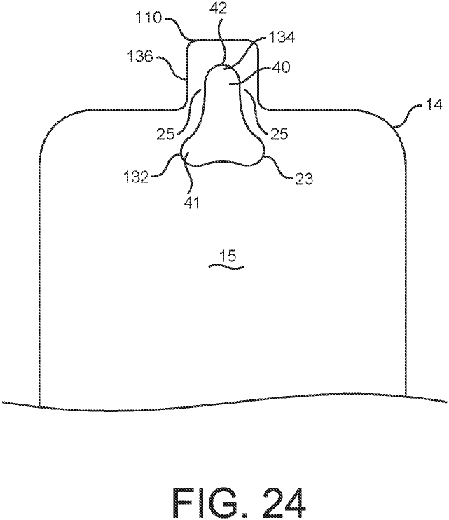

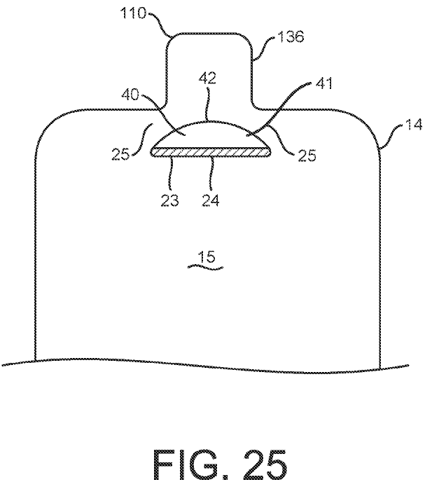

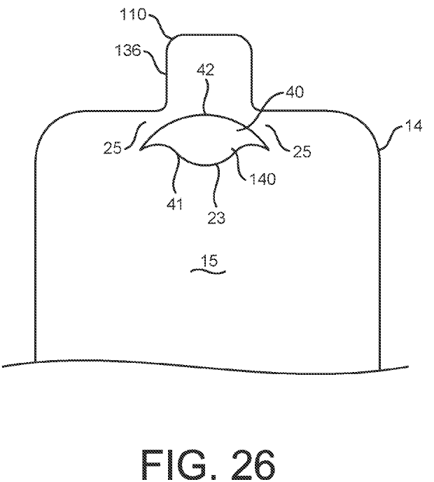

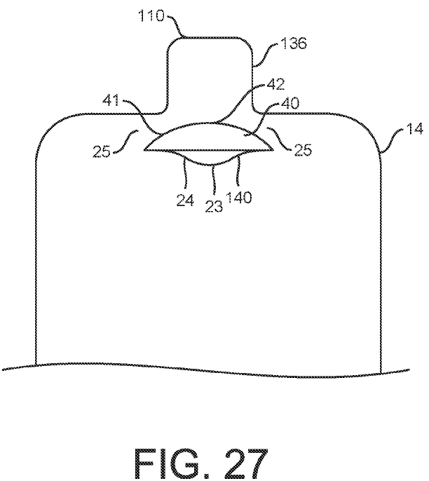

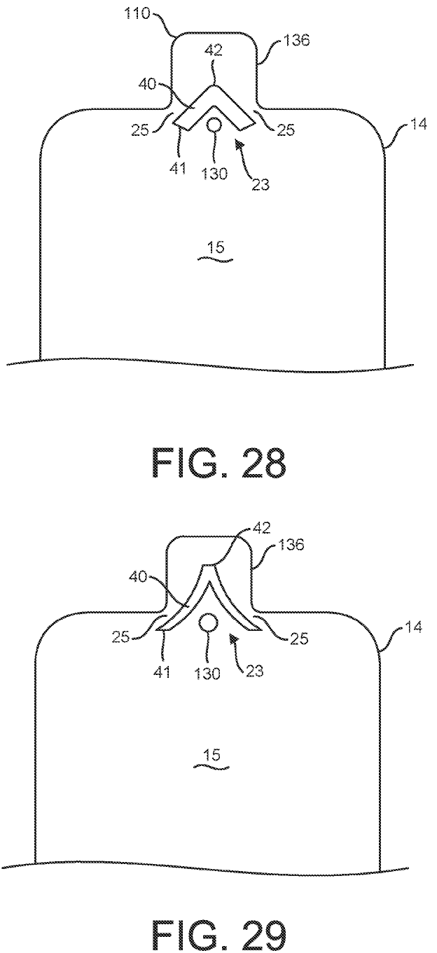

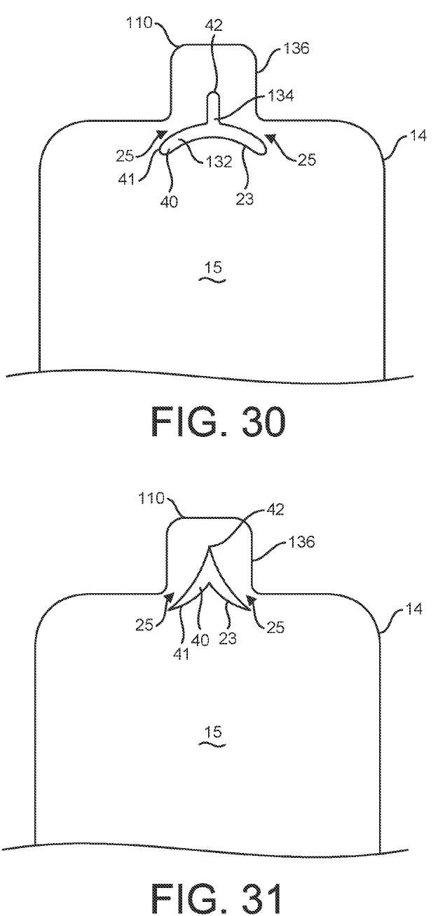

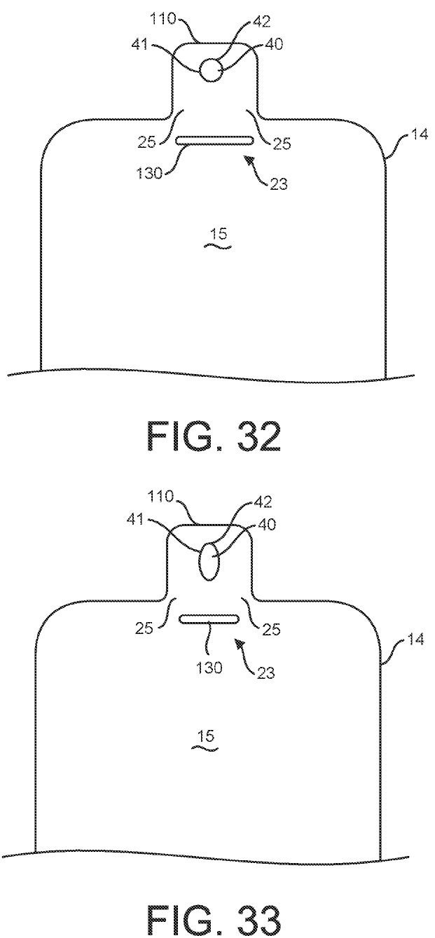

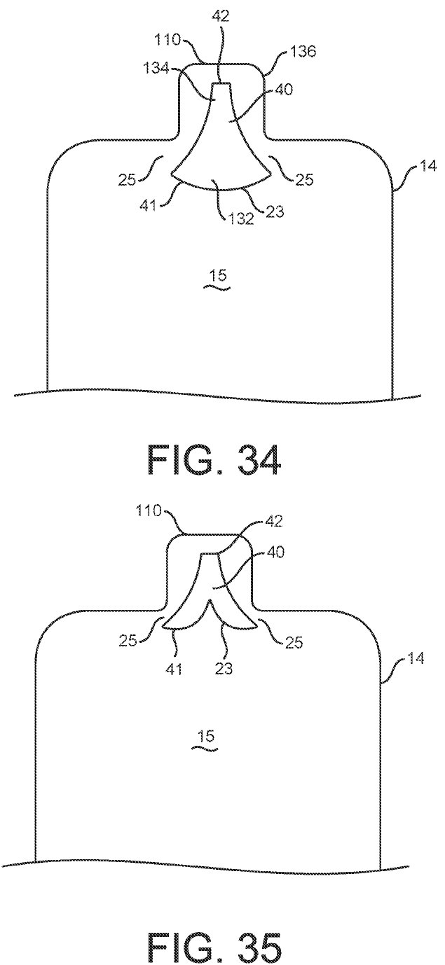

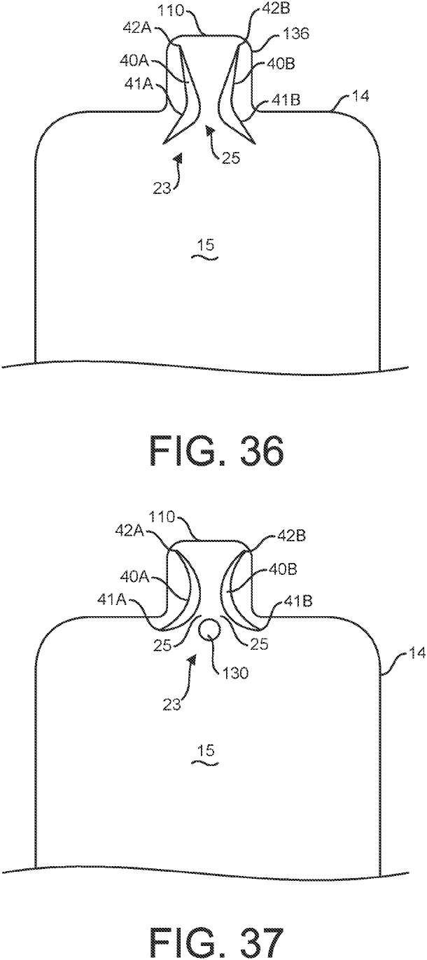

Referring to FIGS. 38 and 39, a further embodiment of a package 10 made in accordance with the present disclosure is shown. FIG. 38 shows the flexible container 14 when the interior volume 15 does not contain a flowable substance, while FIG. 39 shows the flexible container 14 when the interior volume 15 contains a flowable substance. The package 10 of FIGS. 38 and 39 includes a flexible container 14 having an interior volume 15 for receiving a flowable substance and defines a sealed periphery 80. A breachable point 42 is located along the sealed periphery 80 of the flexible container 14. The breachable point 42 of the flexible container 14 includes a weaker seal than the remainder of the sealed periphery 80. The breachable point 42 is designed to breach when pressure is applied to the package without other breaches forming along the periphery.

The package 10 of FIGS. 38 and 39 further contains a fluid channel 20, which includes a fluid outlet and at least one valve-like passageway 25. For example, in FIGS. 38 and 39, the fluid channel 20 includes two valve-like passageways 25. The fluid outlet is located adjacent to the breachable point 42, and the two valve-like passageways 25 are in fluid communication with the interior volume 15 of the flexible container 14.

Referring still to FIGS. 38 and 39, the package 10 additionally includes a self-closing valve 23, which contains a barrier member 24 positioned between the fluid outlet and the interior volume 15 of the flexible container 14. The two valve-like passageways 25 of the flexible container 14 are formed on opposite sides of the barrier member 24 between the barrier member 24 and the sealed periphery 80.

For the package 14 as shown in FIGS. 38 and 39, pressure applied to the flexible container 14 causes the breachable point 42 to breach to dispense controlled amounts of the flowable substance from the interior volume 15 of the flexible container 14. Of advantage, the package can be easily opened using one hand without having to tear away a top strip of the package and without having to use a cutting tool, such as scissors. Further, when pressure is no longer applied to the flexible container 14, the self-closing valve 23 inhibits further flow of the flowable substance through the fluid outlet.

In one embodiment, the fluid channel 20 may contain trapped air, which will then function as a breachable bubble. For example, the fluid channel 20 can be initially free of the flowable substance and be “plump” with air or may contain residual amounts of air. In one aspect, the package 10 is filled with the flowable substance from the bottom in order to trap air in the fluid channel 20. The self-closing valve 23 assists in keeping the fluid channel 20 initially free of the flowable substance. A user can then breach the breachable point 42 and dispense the substance by applying pressure to the package 10. For instance, the user can open the package by pinching the package 10 with a thumb and finger. Once breached, the trapped air is released followed by the flowable substance.

In the embodiment illustrated in FIGS. 38 and 39, the flowable substance exhibits a static pressure and is in direct fluid communication with trapped air contained in the fluid channel 20. In order to prevent the trapped fluid or trapped air in the fluid channel 20 from traveling into the interior volume 15 of the flexible container 14, the flowable substance in the interior volume 15 can have a sufficient static pressure. Specifically, the flowable substance can have a sufficient static pressure such that applying a pressure to the flexible container 14 causes the trapped air contained in the fluid channel 20 to breach through the breachable point 42 of the boundary 110, thereby enabling fluid communication between the fluid channel 20 and the ambient. In other words, when a user applies pressure to the flexible container 14, the fluid product has a sufficient static pressure that the self-closing valve 23, the two valve-like passageways 25, and the fold lines prevent the trapped air in the fluid channel 20 from traveling into the interior volume 15 of the flexible container 14 and instead cause the package to breach.

The self-closing valve of the present disclosure may take a variety of shapes or forms. In one aspect, the self-closing valve 23 may have a triangular shape. However, the self-closing valve 23 can have a variety of other shapes or forms, such as a rectangular shape, a horizontal oval shape, or a heart shape. In one embodiment, the barrier member can be filled with a gas, such as air.

In one aspect, the flexible container 14 of the present disclosure may include a top and a bottom, where the fluid outlet and breachable point 42 are located in a middle of the top, as shown in FIGS. 38 and 39. The fluid outlet and breachable point, however, can be located at a number of locations around the package 10. For example, in one aspect, the fluid outlet and the breachable point 42 may be located at a top corner of the flexible container 14, as shown, for example at least in FIG. 12.

The package 10 of the present disclosure includes a flexible container 14 and an interior volume 15, both of which may have a variety of spatial volumes. For example, in one aspect, the interior volume 15 of the flexible container 14 may have a volume of from about 0.5 ounces to about 5 ounces. Additionally, in another aspect, the flexible container 14 itself may have a volume of from about 5 ounces to about 64 ounces. However, a flexible container 14 or an interior volume 15 may each be employed having different volumes in other packages made in accordance with the present disclosure. The volume or width of the self-closing valve passageways 25 can by altered and adjusted based on the viscosity of the flowable substance and/or the desired flow rate.

In one aspect, the present disclosure may include a strip containing a plurality of packages described in accordance with the present disclosure that are connected together in a sequential manner. For instance, the flexible packages may include a top and a bottom, and the top of a flexible package 14 may be connected to the bottom of an adjacent flexible package 14. In an even further aspect, the packages may be separated by lines of perforations.

In one embodiment, a method for opening a package 10 as defined by the present disclosure is provided. Referring to FIG. 39, for example, the method includes applying pressure to the interior volume 15 of the flexible container 14, causing the breachable point 42 of the package 10 to breach and thereby placing the fluid outlet in communication with the outside environment; and applying further pressure to the flexible container 14, causing the flowable substance contained within the interior volume 15 to exit the flexible container through the self-closing valve 23 and the fluid outlet.

Referring now to FIG. 11, a package 10 is shown that includes a flexible container 14 defining an interior volume 15. In accordance with the present disclosure, the flexible container 14 includes a self-closing valve 23 that is integral with a breachable bubble 40. The self-closing valve 23, for instance, can include a barrier member 24 attached to a breachable bubble 40. The breachable bubble 40 can include a breachable point 42 that faces a boundary 110 of the flexible container 14. During use, a user can burst the breachable bubble 40 along the breaching point 42. Breaching the bubble 40 can, in one embodiment, create pull tabs. A user can use the pull tabs to peel a first flexible film apart from a second flexible film. During the peeling process, a fluid outlet forms that is in fluid communication with the interior volume 15 via valve-like passageways 25.

Alternatively, breaching the bubble 40 can, in one embodiment, cause a fluid outlet to form that is automatically in communication with the valve-like passageways 25 without having to peel apart any pull tabs that are formed during the breaching process.

In one embodiment, the breachable bubble 40 can be used to form a fluid outlet for the flexible container 14 when the bubble is breached. After the bubble 40 is breached, breachable points may still remain within each of the valve-like passageways 25. These breachable points can be breached by applying pressure to the interior volume 15 of the flexible package 14. In this manner, the bubble 40 is used to form a fluid outlet in a first step and in a second step pressure is placed on the flexible container 14 for breaching further points or seals within the container that, once breached, provide fluid communication between the fluid outlet and the valve-like passageways 25.

As shown in FIG. 11, the breachable bubble 40 is generally in the shape of a triangle that forms an extended point that forms the breachable point 42. In FIG. 11, the boundary 110 of the flexible container 14 includes a sharp corner where the breachable bubble 40 and self-closing valve 23 are positioned. Alternatively, however, the flexible container 14 can include a rounded corner.

Referring to FIG. 12, another embodiment of a flexible container 14 made in accordance with the present disclosure is shown. The embodiment of FIG. 12 is very similar to the embodiment illustrated in FIG. 11. The flexible container 14 includes a self-closing valve 23 in combination with a breachable bubble 40. The self-closing valve 23 includes a barrier member 24 that attaches both sides or walls of the flexible container together. The breachable bubble 40 has a triangular shape with a breachable point 42. Applying pressure to the breachable bubble 40 causes the breachable point 42 to breach and break through a sealed portion 120 of the flexible container 14. Once the sealed portion 120 is separated, a fluid outlet is formed that is in fluid communication with the valve-like passageways 25 and the interior volume 15 of the flexible container 14. In the embodiment illustrated in FIG. 12, the boundary 110 of the flexible container 14 includes a rounded corner. In addition, the barrier member 24 in FIG. 12 has a smaller width than the barrier member 24 illustrated in FIG. 11.

Referring now to FIGS. 13 and 14, two other embodiments of flexible containers 14 made in accordance with the present disclosure are shown. Referring to FIG. 13, the flexible container 14 defines an interior volume 15. Attached between two opposing film layers is an integrated self-closing valve 23 and breachable bubble 40. The self-closing valve 23 is defined by a barrier member 24 which also includes a bubble seal for the breachable bubble 40. The breachable bubble 40 includes a breachable point 42 that is directed towards a fluid outlet defined by a boundary 110 of the flexible container 14.

During use, a user can breach the bubble 40 at the breachable point 42 forming a fluid outlet. When the bubble is breached, a pair of opposing pull tabs can be formed for further opening the container so as to form fluid communication between valve-like passageways 25 and the interior volume 15. Alternatively, or in addition, the flexible container 14 may include breachable seals located along the valve-like passageways 25 which can be breached by applying pressure to the interior volume 15 of the flexible container 14 after the breachable bubble 40 has been breached.

The flexible container 14 as shown in FIG. 14 generally includes the same elements and can operate in substantially the same way. In FIGS. 13 and 14, the breachable bubble 40 and the self-closing valve 23 (which are integrated together) have an arc-like shape. More particularly, the self-closing valves 23 and the breachable bubbles 40 have a curved shape such that the concave portion of the curve faces towards the interior volume 15 of the flexible container 14. In FIG. 13, the breachable bubble 40 has a uniform curved shape. In the embodiment illustrated in FIG. 13, however, the breachable bubble 40 has more of an arrow-like shape defining an apex wherein the breachable point 42 is located.

Referring to FIGS. 15 and 16, further embodiments of flexible containers 14 made in accordance with the present disclosure are shown. As illustrated in FIG. 15, the flexible container 14 includes an interior volume 15 in fluid communication with valve-like passageways 25. The flexible container 14 further includes an integrated self-closing valve 23 and breachable bubble 40. The breachable bubble 40 includes a breachable point 42 that faces towards a corner of the package to form a fluid outlet at the boundary 110. Similar to the embodiments illustrated in FIGS. 13 and 14, the bubble seal 41 of the breachable bubble 40 also forms a barrier member for the self-closing valve 23. The breachable bubble 40, when breached, forms a fluid outlet and, as described above, the package can be manipulated so that the fluid outlet formed by the breachable bubble is placed in fluid communication with the valve-like passageways 25.

In the embodiment illustrated in FIG. 15, the self-closing valve 23 and the breachable bubble 40 have a heart-like shape in which the point or apex of the heart faces the boundary 110 of the flexible package 14. The heart-like shape of the breachable bubble 40 may create additional fold lines in the package and can provide greater strength to the package and/or provide better control over the flow properties of the package when a product, such as a fluid, is dispensed from the interior volume 15.

The flexible container 14 as shown in FIG. 16 is substantially similar to the package illustrated in FIG. 15. In FIG. 16, however, the boundary 110 of the flexible container 14 has rounded corners. In addition to having a self-closing valve 23 and a breachable bubble 40 in the shape of a heart, the flexible container 14 as shown in FIG. 16 further includes an additional barrier member 130 spaced from the breachable bubble 40. The barrier member 130 and the breachable bubble 40 form the self-closing valve 23. In the embodiment illustrated in FIG. 16, the barrier member 130 has a round or circular shape that connects the opposing walls of the package together. The barrier member 130 is spaced from the breachable bubble 40 a sufficient distance in order to provide further strength and integrity to the self-closing valve 23 without creating adverse fluid flow characteristics within the flexible container 14. In one embodiment, the barrier member 130 can be a point bond that connects the opposing walls of the flexible container 14.

Referring to FIGS. 17, 18 and 19, further embodiments of packages made in accordance with the present disclosure are shown. In the embodiments illustrated in FIGS. 17-19, the flexible container 14 also includes an integrated self-closing valve 23 and breachable bubble 40. The bubble seal 41 of the breachable bubble 40, for instance, forms the self-closing valve 23. The bubble seal 41 of the breachable bubble 40 also forms valve-like passageways 25 that are in fluid communication with an interior volume 15 for controllably dispensing product from the flexible container 14 to the outside environment through the boundary 110.

In the embodiments illustrated in FIGS. 17-19, the self-closing valve 23 and the breachable bubble 40 have a flute-like shape or a flask-like shape. As shown in FIG. 17, for instance, the breachable bubble 40 includes a conical body 132 in fluid communication with a spout 134. A breachable point 42 is positioned at the end of the spout 134 in the direction of the boundary 110. The breachable bubble 40, when breached, forms a fluid outlet through the boundary 110. In addition, breaching the bubble 40 also provides a means for providing fluid communication between the valve-like passageways 25 and the fluid outlet that is formed.

The flexible container 14 as shown in FIG. 18 is similar in construction to the flexible container 14 shown in FIG. 17. In the embodiment illustrated in FIG. 18, the conical-shaped body 132 of the breachable bubble 40 has a greater width for forming valve-like passageways 25 with a different configuration. As shown in FIGS. 17 and 18, the corner of the flexible container 14 can have a planar region opposite the breachable point 42 for facilitating the formation of a fluid opening when the bubble 40 is breached.

Referring to FIG. 19, a self-closing valve 23 and breachable bubble 40 are illustrated similar to the shapes illustrated in FIGS. 17 and 18. In FIG. 19, however, the conical body 132 has a more rounded shape. In addition, the spout 134 is wider in relation to the conical body 132. In addition, in the embodiment illustrated in FIG. 19, the flexible container 14 includes a neck portion 136 that has a shape that conforms to the shape of the spout 134 of the breachable bubble 40. The neck portion 136 can further define the shape of the valve-like passageways 25 for providing better control over fluid flow. In addition, the neck portion 136 can facilitate formation of a fluid opening once the bubble 40 is breached.

Referring to FIGS. 20 and 21, still further embodiments of flexible containers 14 made in accordance with the present disclosure are illustrated. The flexible containers 14 shown in FIGS. 20 and 21 are similar to the embodiment shown in FIG. 19. For example, as shown in FIG. 20, the flexible container 14 includes an integrated self-closing valve 23 and breachable bubble 40. The breachable bubble 40 includes a bubble seal 41 that forms the barrier member of the self-closing valve. The bubble seal connects between the two outer walls or surfaces of the flexible container 14 and forms valve-like passageways 25. The flexible container 14 includes a sealed end along the boundary 110. The breachable bubble 40 includes a breachable point 42. When pressure is applied to the bubble 40, the bubble forms a fluid outlet through the boundary 110 of the flexible container 14. In addition, the fluid outlet can be placed in fluid communication with the valve-like passageways 25 for controllably dispensing product from the interior volume 15 of the flexible container 14.

In the embodiment illustrated in FIG. 20, the breachable bubble 40 has a bell-like shape that includes a conical-shaped portion 132 and a spout portion 134. The spout portion 134 generally follows the contours of a neck portion 136 of the flexible container 14.

In the embodiment illustrated in FIG. 21, the breachable bubble 40 also includes a body portion 132 and a spout portion 134. The breachable bubble 40 generally includes three triangular lobes to form a flute-like shape as shown in FIGS. 17, 18 and 19. In addition, the self-closing valve 23 further includes a barrier member 130 similar to the barrier member 130 shown in FIG. 16. The barrier member 130 can have a circular shape and can connect the two opposing surfaces of the flexible container 14 for providing further strength to the self-closing valve 23.

Referring now to the flexible containers 14 illustrated in FIGS. 22 and 23, further embodiments of packages made in accordance with the present disclosure are shown in which a self-closing valve 23 is integral with a breachable bubble 40. The self-closing valve 23 and the breachable bubble 40 can be used to open the package similar to any of the embodiments illustrated in FIGS. 11-21. In FIG. 22, the breachable bubble 40 is in the shape of an oval. The oval has an elongated shape defining a breachable point 42. As shown, the elongated body of the bubble 40 faces and corresponds with the neck portion 136 of the flexible container 14 having a boundary 110. A bubble seal 41 serves as a barrier member for the self-closing valve 23 and defines the valve-like passageways 25.

In FIG. 23, the breachable bubble 40 is in the shape of a circle and operates similar to the embodiment illustrated in FIG. 22.

Referring now to FIG. 24, another embodiment of a flexible container 14 is illustrated including a breachable bubble 40 that is integrated with a self-closing valve 23. The embodiment illustrated in FIG. 24 is similar to the embodiment illustrated in FIG. 21. In FIG. 24, however, the self-closing valve 23 is defined exclusively by the bubble seal 41 and does not include a separate barrier member positioned below the breachable bubble 40.

Referring now to FIGS. 25-27, further embodiments of flexible containers 14 made in accordance with the present disclosure are shown. In the embodiments illustrated in FIGS. 25-27, the flexible container 14 includes a breachable bubble 40 having a disc-like shape. The breachable bubble 40 is at least partially integral with a self-closing valve 23. The self-closing valve 23 and the breachable bubble 40 form valve-like passageways 25 that extend into a neck portion 136 of the flexible container 14. The valve-like passageways 25 are in fluid communication with an interior volume 15 of the flexible container 14.

As shown in FIG. 25, the breachable bubble 40 includes a bubble seal 41 and a breachable point 42. The flexible container 14 further includes a barrier member 24. In this embodiment, the self-closing valve 23 is formed by the barrier member 24 in conjunction with the bubble seal 41. The breachable bubble 40 is configured to breach in the direction of the neck portion 136 through the breachable point 42 for forming a fluid opening through the boundary 110. By peeling back pull tabs once the bubble 40 is breached or by adding further pressure to the interior volume 15 of the flexible container 14, the fluid outlet formed by the breachable bubble 40 can be placed in fluid communication with the valve-like passageways 25.

In FIG. 26, the breachable bubble 40 has a similar shape to the embodiment illustrated in FIG. 25 except the breachable bubble 40 includes a hump portion positioned opposite the breachable point 42 and the neck portion 136. Further, the bubble seal 41, in this embodiment, forms the entire self-closing valve 23. As shown in FIGS. 25 and 26, the breachable bubble 40 includes a concave-shaped surface that faces the neck portion 136.

Referring now to the flexible container 14 shown in FIG. 27, the breachable bubble 40 and the self-closing valve 23 have a shape similar to the breachable bubble 40 illustrated in FIG. 26. In the embodiment illustrated in FIG. 27, however, a hump portion 140 is separated by a further barrier member and thus is not part of the breachable bubble 40. Instead, the flexible container 14 includes a separate barrier member 24 that extends from the breachable bubble 40 for forming the self-closing valve 23.

Referring to FIGS. 28 and 29, further embodiments of flexible containers 14 made in accordance with the present disclosure are shown. The flexible containers 14 as shown in FIGS. 28 and 29 are very similar to the flexible container 14 illustrated in FIG. 14. More particularly, the breachable bubble in the embodiments illustrated in FIGS. 28 and 29 are in the shape of an arrow having an apex where the breachable point 42 is located. The apex of each breachable bubble 40 faces a neck portion 136 of the flexible container 14. The breachable bubble 40 forms valve-like passageways 25 for forming a self-closing valve 23. In the embodiments illustrated in FIGS. 28 and 29, the self-closing valve 23 further includes a barrier member 130 that connects one side of the package with an opposite side of the package for providing strength and integrity. As shown in FIGS. 28 and 29, the barrier member 130 can be in the shape of a circle. In other embodiments, however, the barrier member 130 can have any suitable shape, such as rectangular, square, or a complex shape.

Referring to FIG. 31, a further embodiment of a breachable bubble 40 illustrated in an arrow-like shape is shown. The embodiment illustrated in FIG. 31 is similar in construction and function to the embodiment illustrated in FIG. 14. The breachable bubble 40, for instance, includes a bubble seal 41 that also serves as forming a self-closing valve 23 and the formation of valve-like passageways 25.

Referring to FIG. 30, still another embodiment of a flexible container 14 made in accordance with the present disclosure is shown. The flexible container 14 includes a breachable bubble 40 having a breach point 42 and being formed by a bubble seal 41. The bubble seal 41 also forms a self-closing valve 23 defining valve-like passageways 25. The breachable bubble 40 is similar in configuration to the embodiment illustrated in FIG. 13. In the embodiment illustrated in FIG. 30, however, the bubble 40 includes not only a body portion 132 but also a spout portion 134 that extends into the neck portion 136 of the flexible container 14. The spout portion 134 can facilitate formation of a fluid opening when the bubble is breached and can better define the fluid passageways 25.

Referring to FIGS. 32 and 33, further embodiments of flexible containers 14 made in accordance with the present disclosure are shown. In FIGS. 32 and 33, a breachable bubble 40 defined by a bubble seal 41 and a breachable point 42 forms part of a self-closing valve 23. The self-closing valve 23, however, further includes a barrier member 130 which, in the embodiments illustrated, is in the shape of a horizontal rod-like member. The embodiment of FIG. 32 is very similar in design and function to the embodiment illustrated in FIG. 23. The embodiment illustrated in FIG. 33 is very similar in design and function to the embodiment illustrated in FIG. 22. The embodiments illustrated in FIGS. 32 and 33, however, include the additional barrier member 130 that connects the opposing walls of the package together and can have various different functions and uses. For instance, the barrier member 130 can better define the valve-like passageways 25 and can provide further structure and integrity to the package. In addition, the barrier members 130 can change the position of the fold lines of the packages after the bubbles 40 have been breached and during dispensing of products from the flexible containers 14 by applying pressure to the interior volume 15.

Referring to FIG. 34, a flexible container 14 made in accordance with the present disclosure is shown containing an integrated breachable bubble 40 and self-closing valve 23. More particularly, the breachable bubble 40 includes a bubble seal 41 that defines the self-closing valve 23 and forms the valve-like passageways 25. The breachable bubble 40 includes a breachable point 42 facing the boundary 110 of the flexible container 14 and within a neck portion 136. The embodiment illustrated in FIG. 34 is very similar in shape and function as to the flexible container 14 shown in FIG. 17. In FIG. 34, however, the body portion 132 of the flexible bubble gradually extends into the spout portion 134 of the breachable bubble 40.

Referring to FIG. 35, still another embodiment of a flexible container made in accordance with the present disclosure is shown. In FIG. 35, the self-closing valve 23 and the breachable bubble 40 are very similar in design and function as to the embodiment illustrated in FIG. 31. As shown, the breachable bubble 40 has an arrow-like shape and may be described as having the shape of a “fish tail”.

In the embodiments illustrated in FIGS. 11-35 and FIGS. 38 and 39, each of the flexible containers includes a single breachable bubble. Referring to FIGS. 36 and 37, further embodiments of flexible containers 14 made in accordance with the present disclosure are shown. In FIGS. 36 and 37, each flexible container 14 contains two different breachable bubbles that cooperate together to form valve-like passageways 25 and a self-closing valve 23.

Referring to FIG. 36, for instance, the flexible container 14 includes a first breachable bubble 40A spaced from a second breachable bubble 40B. The breachable bubbles 40A and 40B have a curved or “boomerang” shape. Each breachable bubble 40A and 40B includes a bubble seal 41A and 41B and a breachable point 42A and 42B that faces a boundary 110. In the embodiment illustrated, the breachable bubbles 40A and 40B are located primarily in the neck portion 136 of the flexible container 14.

The two cooperating breachable bubbles 40A and 40B also form a self-closing valve 23 defining a valve-like passageway 25. When a user desires to open the package and dispense the contents, a user applies pressure to the breachable bubbles 40A and 40B for causing a breach through the boundary 110. A user can then peel opposing sides or walls of the container for producing a pour spout that is in fluid communication with the valve-like passageway 25. Applying pressure to the interior volume 15 allows for controlled flow of product through the fluid outlet.

Referring to FIG. 37, the flexible container 14 is very similar in shape and function to the embodiment illustrated in FIG. 36. In FIG. 37, however, the opposing breachable bubbles 40A and 40B have a “crescent moon-like shape”.

In the embodiment illustrated in FIG. 37, the flexible container 14 further includes a barrier member 130 that attaches the opposing walls of the container together. The barrier member 130 can have any suitable shape. In the embodiment illustrated, the barrier member 130 has a circular shape and is spaced from the breachable bubbles 40A and 40B for forming valve-like passageways 25. The barrier member 130 can provide greater strength and integrity to the package and can provide for better control over fluid flow through a fluid outlet formed by the breachable bubbles 40A and 40B.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A package comprising:
a flexible container having an interior volume for receiving a flowable substance, the flexible container defining a sealed periphery;
a breachable point located along the sealed periphery of the flexible container, the breachable point having a weaker seal than the remainder of the sealed periphery;
a fluid channel comprising a fluid outlet and at least one valve-like passageway, the fluid outlet being located adjacent to the breachable point, the at least one valve-like passageway being in fluid communication with the interior volume of the flexible container;
a self-closing valve comprising a barrier member positioned between the fluid outlet and the interior volume of the flexible container, the at least one valve-like passageway being formed between the barrier member and the sealed periphery, and wherein pressure applied to the flexible container causes the breachable point to breach for dispensing controlled amounts of the flowable substance from the interior volume of the container and wherein, when pressure is no longer applied, the self-closing valve inhibits further flow of the flowable substance through the fluid outlet.

2. A package as defined in claim 1, wherein the fluid channel initially contains trapped air that causes the breachable point to breach when pressure is applied to the flexible container, the trapped air being released through the fluid outlet before the flowable substance is dispensed.

3. A package as defined in claim 1, wherein the fluid channel includes a first valve-like passageway located on one side of the barrier member and a second valve-like passageway located on an opposite side of the barrier member.

4. A package as defined in claim 1, wherein the self-closing valve has a triangular shape.

5. A package as defined claim 1, wherein the barrier member comprises a bubble filled with a gas.

6. A package as defined in claim 1, wherein the barrier member has a shape that forms folds in the flexible container that cause the flexible container walls to prevent liquid flow through the valve-like passageway absent external pressure.

7. A package as defined in claim 1, wherein the flexible container includes a top and a bottom, the fluid outlet and breachable point being located in a middle of the top.

8. A package as defined in claim 1, wherein the flexible container includes a top and a bottom, the fluid outlet and breachable point being located at a top corner of the flexible container.

9. A package as defined in claim 1, wherein the interior volume of the flexible container has a volume of from about 0.5 ounces to about 5 ounces.

10. A package as defined in claim 1, wherein the interior volume of the flexible container has a volume of from about 5 ounces to about 64 ounces.

11. A package as defined in claim 1, wherein the barrier member is transverse to an end of the fluid channel.

12. A package as defined in claim 1, wherein the barrier member has a generally rectangular or horizontal oval shape.

13. A package as defined in claim 1, wherein the barrier member is formed by attaching together opposing container walls.

14. A package as defined in claim 1, wherein the flexible container is comprised of a flexible polymer film.

15. A package as defined in claim 1, wherein the flexible container is comprised of a flexible metallized film.

16. A strip containing a plurality of packages as defined in claim 1.

17. A strip as defined in claim 16, wherein the flexible packages include a top and a bottom and wherein the top of a flexible package is connected to the bottom of an adjacent flexible package.

18. A strip as defined in claim 16, wherein the packages are separated by lines of perforations.

19. A method for opening the package as defined in claim 1 comprising:
applying pressure to the interior volume of the flexible package causing the breachable point to breach and thereby placing the fluid outlet in communication with the outside environment; and
applying further pressure to the flexible container to cause the flowable substance contained within the interior volume to exit the flexible container through the self-closing valve and the fluid outlet.
